(19) United States
(12) Patent Application Publication
(10) Pub. No.: US 2023/0198717 A1
(43) Pub. Date: Jun. 22, 2023

(54) CONSIDERATIONS OF DATA CHANNEL-BASED CHANNEL STATE INFORMATION PERIODICITY

(71) Applicant: QUALCOMM Incorporated, San Diego, CA (US)

(72) Inventors: Ahmed Elshafie, San Diego, CA (US); Wei Yang, San Diego, CA (US); Tugcan Aktas, La Jolla, CA (US); Seyedkianoush Hosseini, San Diego, CA (US)

(21) Appl. No.: 17/556,637

(22) Filed: Dec. 20, 2021

(51) Int. Cl. H04L 5/00; H04W 24/10; H04W 72/14

(52) U.S. Cl. CPC H04L 5/0053; H04W 24/10; H04W 72/14

(57) ABSTRACT

Methods, systems, and devices for wireless communications are described. A method for wireless communication is described that includes receiving, at a user equipment (UE), via a control channel, configuration information for communications between the UE and a wireless device over reserved resources. The method further includes identifying, from the configuration information, an indication of a channel state information (CSI) report periodicity and transmitting a CSI report for a data channel in accordance with the CSI report periodicity. Another method includes generating a sidelink control information (SCI) message including an indication of a presence or absence of a CSI reference signal (CSI-RS) in a sidelink channel message and transmitting the sidelink control information message. Another method includes receiving a SCI message including an indication of a CSI-RS in a sidelink channel message, and generating and transmitting a CSI report for a data channel based at least in part on the indication.

### FIELD OF TECHNOLOGY

The following relates to wireless communications, including considerations of data channel-based channel state information periodicity.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

When a base station and a UE communicate over a wireless channel, information about the conditions of the wireless channel may be used to improve conditions. Channel state information (CSI) reports may include information about the conditions or characteristics of a wireless channel. A UE may provide a CSI report to a base station.

### SUMMARY

The described techniques relate to improved methods, systems, devices, and apparatuses that support considerations of data channel-based channel state information periodicity. Generally, the described techniques provide for configuration of periodic CSI reports. A periodicity for CSI reports can be set by a base station for Uu link transmissions or a transmitting UE (e.g., a Tx-UE) for sidelink transmissions. A Uu link may be a link between a base station and a UE. A sidelink communication may be any direct communication between two or more UEs, or other types of wireless devices, that does not go through a base station.

An indication of a CSI report periodicity may be sent to a receiving UE (e.g., an Rx-UE) via a control channel, which may be sent in a configured grant (CG) or a radio resource control (RRC) message. Techniques are also provided for updating the CSI report periodicity once a CSI periodicity has been configured. Techniques are also described that inform when the UE or other wireless device is to begin a period by sending a first CSI report. Further, a flag is defined that may be used to indicate whether there are CSI reference signal (CSI-RS) resources in a current channel, which may be used in generating CSI.

A method for wireless communication at a UE is described. The method may include receiving, at the UE and via a control channel, configuration information for communications between the UE and a wireless device over one or more reserved resources. The method may also include identifying, from the configuration information, an indication of a CSI report periodicity. The method may also include transmitting a CSI report for a data channel in accordance with the CSI report periodicity.

An apparatus for wireless communication at a UE is described. The apparatus may include a processor, memory coupled with the processor, and instructions stored in the memory. The instructions may be executable by the processor to cause the apparatus to receive, at the UE and via a control channel, configuration information for communications between the UE and a wireless device over one or more reserved resources. The instructions may be further executable by the processor to cause the apparatus to identify, from the configuration information, an indication of a CSI report periodicity and transmit a CSI report for a data channel in accordance with the CSI report periodicity.

Another apparatus for wireless communication at a UE is described. The apparatus may include means for receiving, at the UE and via a control channel, configuration information for communications between the UE and a wireless device over one or more reserved resources. The apparatus may also include means for identifying, from the configuration information, an indication of a CSI report periodicity and means for transmitting a CSI report for a data channel in accordance with the CSI report periodicity.

A non-transitory computer-readable medium storing code for wireless communication at a UE is described. The code may include instructions executable by a processor to receive, at the UE and via a control channel, configuration information for communications between the UE and a wireless device over one or more reserved resources. The code may also include instructions executable by the processor to receive identify, from the configuration information, an indication of a CSI report periodicity, and transmit a CSI report for a data channel in accordance with the CSI report periodicity.

In some examples of the method, apparatuses, and non-transitory computer-readable medium described herein, identifying the indication of the CSI report periodicity may include operations, features, means, or instructions for identifying the sidelink-based CSI report periodicity as a sidelink-based CSI report periodicity which may be in terms of sidelink shared channel occasions.

In some examples of the method, apparatuses, and non-transitory computer-readable medium described herein, receiving the configuration information may include operations, features, means, or instructions for receiving the indication of the CSI report periodicity via a radio resource control message from the wireless device, where the CSI report periodicity may be a sidelink-based CSI report periodicity and the wireless device may be a base station.

In some examples of the method, apparatuses, and non-transitory computer-readable medium described herein, receiving the configuration information may include operations, features, means, or instructions for receiving the indication of the CSI report periodicity via a sidelink control channel, where the CSI report periodicity may be a sidelink-based CSI report periodicity.

Some examples of the method, apparatuses, and non-transitory computer-readable medium described herein may further include operations, features, means, or instructions for updating the CSI report periodicity according to traffic statistics over the data channel, a change in a data channel characteristic, a rate of change of data channel characteristics of the data channel, a sequence of negative acknowledgement events, a sequence of acknowledgement events, or a function based on a number of negative acknowledgements.

Some examples of the method, apparatuses, and non-transitory computer-readable medium described herein may further include operations, features, means, or instructions for receiving, from the wireless device, an indication of an updated CSI report periodicity via the control channel, where updating the CSI report periodicity may be based on the indication of the updated CSI report periodicity, and where the wireless device may be a base station.

Some examples of the method, apparatuses, and non-transitory computer-readable medium described herein may further include operations, features, means, or instructions for receiving a reactivation downlink control information message, where updating the CSI report periodicity may be based on the reactivation downlink control information message.

Some examples of the method, apparatuses, and non-transitory computer-readable medium described herein may further include operations, features, means, or instructions for receiving a configured grant message that identifies resources for sidelink transmissions, where the indication of the CSI report periodicity may be indicated in the configured grant message.

Some examples of the method, apparatuses, and non-transitory computer-readable medium described herein may further include operations, features, means, or instructions for applying the CSI report periodicity upon an occurrence of a trigger.

In some examples of the method, apparatuses, and non-transitory computer-readable medium described herein, the trigger includes receiving a configured grant or a start of a time slot reservation.

In some examples of the method, apparatuses, and non-transitory computer-readable medium described herein, identifying the indication of the CSI report periodicity may include operations, features, means, or instructions for receiving indications of a set of multiple CSI report periodicities via the control channel and selecting the CSI report periodicity from the set of multiple CSI report periodicities based on one or more parameters.

In some examples of the method, apparatuses, and non-transitory computer-readable medium described herein, the one or more parameters include a number of negative acknowledgement events, a number of acknowledgement events, a change in a data channel characteristic, and a processing load of the UE.

In some examples of the method, apparatuses, and non-transitory computer-readable medium described herein, identifying the indication of the CSI report periodicity may include operations, features, means, or instructions for receiving the indication of the CSI report periodicity in a sidelink control information message.

In some examples of the method, apparatuses, and non-transitory computer-readable medium described herein, the CSI report periodicity may be based on one or more of an application priority level or a quality of service value of the data channel.

Some examples of the method, apparatuses, and non-transitory computer-readable medium described herein may further include operations, features, means, or instructions for receiving a configuration of an application priority level associated with the CSI report periodicity in a radio resource configuration message or a downlink control information message.

A method for wireless communication at a first wireless device is described. The method may include generating a sidelink control information message including an indication indicating a presence or an absence of a CSI reference signal in a sidelink channel message and transmitting the sidelink control information message to a second wireless device.

An apparatus for wireless communication at a first wireless device is described. The apparatus may include a processor, memory coupled with the processor, and instructions stored in the memory. The instructions may be executable by the processor to cause the apparatus to generate a sidelink control information message including an indication indicating a presence or an absence of a CSI reference signal in a sidelink channel message and transmit the sidelink control information message to a second wireless device.

Another apparatus for wireless communication at a first wireless device is described. The apparatus may include means for generating a sidelink control information message including an indication indicating a presence or an absence of a CSI reference signal in a sidelink channel message and means for transmitting the sidelink control information message to a second wireless device.

A non-transitory computer-readable medium storing code for wireless communication at a first wireless device is described. The code may include instructions executable by a processor to generate a sidelink control information message including an indication indicating a presence or an absence of a CSI reference signal in a sidelink channel message and transmit the sidelink control information message to a second wireless device.

In some examples of the method, apparatuses, and non-transitory computer-readable medium described herein, the indication includes a one-bit flag and a first value of the one-bit flag indicates that the CSI reference signal may be present in the sidelink channel message and a second value of the one-bit flag indicates that the CSI reference signal may be absent from the sidelink channel message.

In some examples of the method, apparatuses, and non-transitory computer-readable medium described herein, generating the sidelink control information message may include operations, features, means, or instructions for setting, based on a physical sidelink control channel occasion, a CSI request indicator in the sidelink control information message that indicates to the second wireless device to send a CSI report in a next available physical sidelink control channel resource.

A method for wireless communication at a first wireless device is described. The method may include receiving, from a second wireless device, a sidelink control information message including an indication indicating a presence or an absence of a CSI reference signal in a sidelink channel message. The method may also include generating a CSI report for a data channel based on the indication and transmitting the CSI report to the second wireless device.

An apparatus for wireless communication at a first wireless device is described. The apparatus may include a processor, memory coupled with the processor, and instructions stored in the memory. The instructions may be executable by the processor to cause the apparatus to receive, from a second wireless device, a sidelink control information message including an indication indicating a presence or an absence of a CSI reference signal in a sidelink channel message. The instructions also may be executable by the processor to cause the apparatus to generate a CSI report for a data channel based on the indication and transmit the CSI report to the second wireless device.

Another apparatus for wireless communication at a first wireless device is described. The apparatus may include means for receiving, from a second wireless device, a sidelink control information message including an indication indicating a presence or an absence of a CSI reference signal in a sidelink channel message. The apparatus may further include means for generating a CSI report for a data channel based on the indication and means for transmitting the CSI report to the second wireless device.

A non-transitory computer-readable medium storing code for wireless communication at a first wireless device is described. The code may include instructions executable by a processor to receive, from a second wireless device, a sidelink control information message including an indication indicating a presence or an absence of a CSI reference signal in a sidelink channel message. The code may include instructions executable by the processor to generate a CSI report for a data channel based on the indication and transmit the CSI report to the second wireless device.

In some examples of the method, apparatuses, and non-transitory computer-readable medium described herein, the indication includes a one-bit flag and a first value of the one-bit flag indicates that the CSI reference signal may be present in the sidelink channel message and a second value of the one-bit flag indicates that the CSI reference signal may be absent from the sidelink channel message.

In some examples of the method, apparatuses, and non-transitory computer-readable medium described herein, receiving the sidelink control information message may include operations, features, means, or instructions for identifying a CSI request indicator in the sidelink control information message that indicates when to transmit the CSI report, where transmitting the CSI report may be based on the CSI request indicator.

A method is described. The method may include determining one or more CSI report periodicities and transmitting, to a UE and via a control channel, configuration information for communications between the UE and a wireless device over one or more reserved resources, where the configuration information includes the one or more CSI report periodicities.

An apparatus is described. The apparatus may include a processor, memory coupled with the processor, and instructions stored in the memory. The instructions may be executable by the processor to cause the apparatus to determine one or more CSI report periodicities and transmit, to a UE and via a control channel, configuration information for communications between the UE and a wireless device over one or more reserved resources, where the configuration information includes the one or more CSI report periodicities.

Another apparatus is described. The apparatus may include means for determining one or more CSI report periodicities and means for transmitting, to a UE and via a control channel, configuration information for communications between the UE and a wireless device over one or more reserved resources, where the configuration information includes the one or more CSI report periodicities.

A non-transitory computer-readable medium storing code is described. The code may include instructions executable by a processor to determine one or more CSI report periodicities and transmit, to a UE and via a control channel, configuration information for communications between the UE and a wireless device over one or more reserved resources, where the configuration information includes the one or more CSI report periodicities.

### BRIEF DESCRIPTION OF THE DRAWINGS

FIG. 1 illustrates an example of a wireless communications system that supports considerations of data channel-based CSI periodicity in accordance with aspects of the present disclosure.

FIG. 2 illustrates an example of a wireless communications system that supports considerations of data channel-based CSI periodicity in accordance with aspects of the present disclosure.

FIGS. 3 and 4 illustrate example process flows that support considerations of data channel-based CSI periodicity in accordance with aspects of the present disclosure.

FIGS. 5, 6, and 7 illustrate example timing diagrams that support considerations of data channel-based CSI periodicity in accordance with aspects of the present disclosure.

FIGS. 8 and 9 show block diagrams of devices that support considerations of data channel-based CSI periodicity in accordance with aspects of the present disclosure.

FIG. 10 shows a block diagram of a communications manager that supports considerations of data channel-based CSI periodicity in accordance with aspects of the present disclosure.

FIG. 11 shows a diagram of a system including a device that supports considerations of data channel-based CSI periodicity in accordance with aspects of the present disclosure.

FIGS. 12 and 13 show block diagrams of devices that support considerations of data channel-based CSI periodicity in accordance with aspects of the present disclosure.

FIG. 14 shows a block diagram of a communications manager that supports considerations of data channel-based CSI periodicity in accordance with aspects of the present disclosure.

FIG. 15 shows a diagram of a system including a device that supports considerations of data channel-based CSI periodicity in accordance with aspects of the present disclosure.

FIGS. 16 through 19 show flowcharts illustrating methods that support considerations of data channel-based CSI periodicity in accordance with aspects of the present disclosure.

### DETAILED DESCRIPTION

Wireless devices may exchange information related to channel conditions in order to improve their communication. One technique for exchanging channel condition information is for a wireless device that receives a data packet to provide CSI if the wireless device is unable to decode the data packet. The wireless device may send a CSI report based on determining a negative acknowledgement for the data packet. However, it may be useful for a wireless device to periodically send CSI reports during communications with another wireless device.

Techniques described herein define several scenarios regarding CSI communications between a base station, a transmitting UE, and a receiving UE. The communications between the base station and the transmitting UE or receiving UE may be over a Uu link, while the communications between the transmitting UE and the receiving UE may be over a sidelink.

For example, a base station or a transmitting UE may define a CSI report periodicity for a receiving UE to use. The CSI report periodicity may be indicated to the transmitting UE or the receiving UE via different configurations. The transmitting UE may inform a receiving UE of resource allocation information so that the receiving UE may apply the CSI report periodicity. The CSI report periodicity may be modified with explicit signaling in a reactivated downlink control channel or may be modified without explicit signaling at the receiving UE. For example, the CSI report periodicity may be modified at the receiving UE based on a number of observed negative acknowledgements (NACKs) since the CSI report period began.

In some examples, the CSI report periodicity may be configured along with configuration of a resource pool, and when the resources are triggered, the CSI report periodicity may be applied. In some examples, the transmitting UE may indicate the CSI report periodicity in sidelink control information messages.

In additional examples, the CSI report periodicity may be associated with or based on an application priority or a quality of service. The priority levels and the CSI report periodicity may be RRC configured. In some examples, the values of the priority levels may be signaled in a media access control (MAC) control element (MAC-CE) or in downlink control information (DCI).

Some techniques describe a flag that can indicate whether a triggered CSI report (on MAC-CE) is CSI-RS based or a physical sidelink shared channel (PSSCH) or physical sidelink control channel (PSCCH) based. In some examples, a special carrier may be created for CSI reports. A two-stage feedback on PUCCH is also described.

Many of these techniques may be applicable to both Uu and sidelink environments.

The techniques described herein may improve network efficiency through increasing the spectral efficiency of the entire wireless communications system, improve efficient utilization of communication resources, reduce interference, reduce retransmissions by increasing reliability of transmissions, reduce power consumption leading to a longer battery life due to less retransmissions, and improve user experience. The described techniques may also improve communication reliability, improve coordination between devices, and reduce latency. The techniques described herein also improve low latency and high reliability for sidelink applications (such as, for example, IIoT, XR, and smart wearables). The techniques may provide a robust CSI, reduce the chance of overloading a PUCCH (in the Uu link) or overloading in a PSFCH (in the sidelink), and reduce processing of channel quality information at the UE. The techniques also provide for more flexibility with regards to CSI reporting.

Aspects of the disclosure are initially described in the context of wireless communications systems. Aspects of the disclosure are further illustrated by and described with reference to process flows and timing diagrams. Aspects of the disclosure are further illustrated by and described with reference to apparatus diagrams, system diagrams, and flowcharts that relate to considerations of data channel-based CSI periodicity.

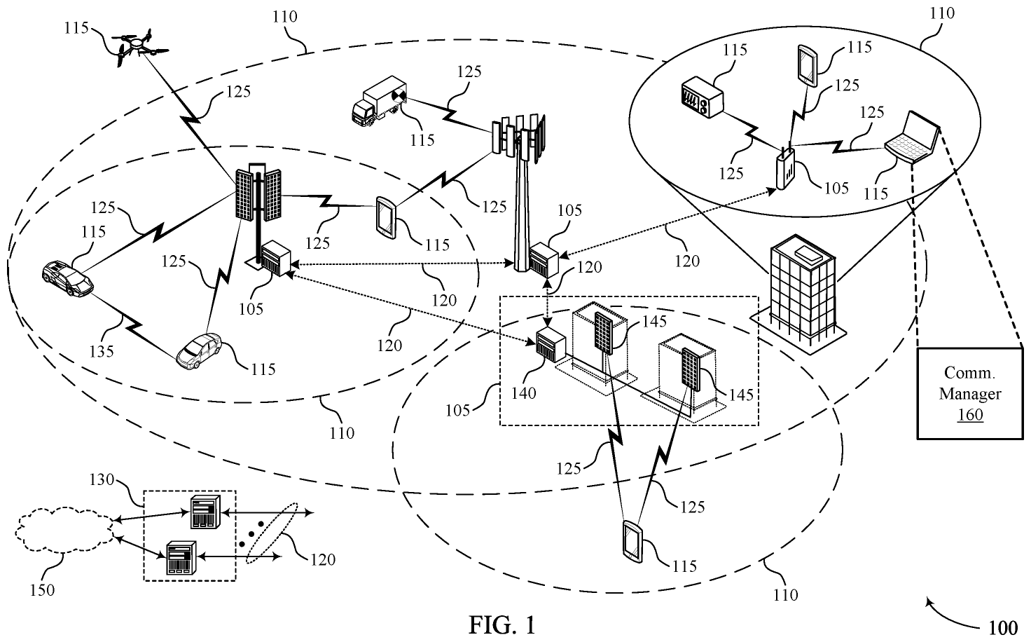

FIG. 1 illustrates an example of a wireless communications system 100 that supports considerations of data channel-based CSI periodicity in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The UE 115 may include a communications manager 160, which may support considerations of data channel-based CSI periodicity. In some examples, the communications manager 160 may receive, at the UE and via a control channel, configuration information for communications between the UE and a wireless device over one or more reserved resources. The communication manager 160 may identify, from the configuration information, an indication of a CSI report periodicity. The communication manager 160 may transmit a CSI report for a data channel in accordance with the CSI report periodicity.

In another example, the communications manager 160 may generate a sidelink control information message including an indication indicating a presence or an absence of a channel state information reference signal in a sidelink channel message. The communication manager 160 may transmit the sidelink control information message to a second wireless device.

In another example, the communications manager 160 may receive, from a second wireless device, a SCI message including an indication indicating a presence or an absence of a CSI-RS in a sidelink channel message. The communication manager 160 may generate a CSI report for a data channel based at least in part on the indication and transmit the CSI report to the second wireless device.

In another example, a base station 105 may include a communications manager. The base station communication manager may determine one or more channel state information report periodicities. The base station communication manager may further transmit, to a UE and via a control channel, configuration information for communications between the UE and a wireless device over one or more reserved resources, wherein the configuration information includes the one or more channel state information report periodicities.

The techniques described herein enable a base station or a UE to configure a periodicity of transmitting and receiving CSI reports. Configuration information messages may be sent that include an indication of one or more CSI report periodicities. The configuration information may be sent by a UE or a base station to a receiving UE. The configuration information may be sent in a control channel, such as in a RRC message or in DCI. The CSI report may be for a data channel, which may be in a Uu link or a sidelink. The techniques described herein may also include an indication in a SCI message that indicates a presence or an absence of a CSI-RS in a sidelink channel message.

The techniques described herein may improve network efficiency through increasing the spectral efficiency of the entire wireless communications system, improve efficient utilization of communication resources, reduce interference, reduce retransmissions by increasing reliability of transmissions, reduce power consumption leading to a longer battery life due to less retransmissions, and improve user experience. The described techniques may also improve communication reliability, improve coordination between devices, and reduce latency. The techniques described herein also improve low latency and high reliability for sidelink applications (such as, for example, industrial internet of things (IIoT), consumer use cases, extended reality (XR), and smart wearables).

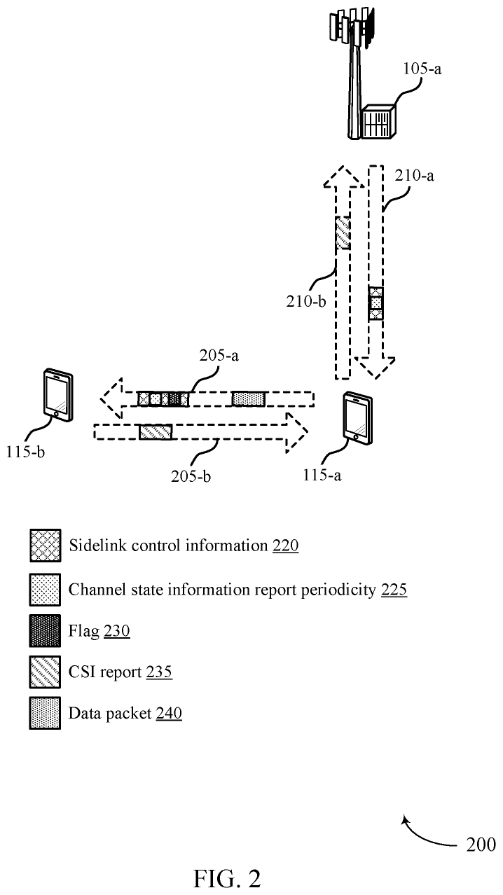

FIG. 2 illustrates an example of a wireless communications system 200 that supports considerations of data channel-based CSI periodicity in accordance with aspects of the present disclosure. The wireless communications system 200 may include a first UE 115-a, a second UE 115-b, and a base station 105-a that may be examples of one or more aspects of a UE 115 or base station 105 as described herein. As described with respect to the example of FIG. 2, the first UE 115-a and the second UE 115-b may be collectively referred to as UEs 115. The UEs 115 may each be served by the base station 105-a, or by another base station. In some cases, the UEs 115-a and 115-b and the base station 105-a may implement techniques described herein for data channel-based CSI periodicity.

In some wireless communications systems, such as wireless communications system 200, a UE 115 may communicate with one or more other UEs 115 via sidelink communication links 205, such as sidelink communication links 205-a and 205-b. The UEs 115 may have sidelink interfaces, such as PC5 interfaces. The sidelink interfaces may enable the UEs 115 to directly communicate with each other over sidelink.

A UE 115 may communicate with a base station 105 over a Uu link. For example, the UE 115-a communicates with the base station 105-a over Uu links 210-a and 210-b.

For example, a first UE 115-a may transmit SCI 220 via sidelink communications link 205-a (e.g., via a sidelink control channel signal, such as a PSCCH) to the second UE 115-b. The transmissions may be broadcast or unicast (e.g., beamformed towards the intended recipients). The UEs 115-a may have included a CSI report periodicity 225 in the SCI 220. The SCI 220 may be transmitted in a control channel, such as a PSCCH or a physical downlink control channel (PDCCH).

The first UE 115-a may have independently determined the SCI report periodicity 225 or may have received a configuration of the SCI report periodicity 225 from the base station 105-a over the Uu link 210-a. In some examples, the indication of the SCI report periodicity 225 may indicate a single SCI report periodicity or may indicate a set of SCI report periodicities. As used herein, the phrase “a set” shall be construed as including the possibility of a set with one member. That is, the phrase “a set” shall be construed in the same manner as “one or more.” If a set of SCI report periodicities is sent to the second UE 115-b, the second UE 115-b may choose one of the SCI report periodicities to use.

In some examples, the base station 105-a may configure the first UE 115-a with the CSI report periodicity 225. The first UE 115-a may provide this configuration to the second UE 115-b. In other examples, the first UE 115-a may use the CSI report periodicity to send CSI reports to the base station 105-a.

Upon determining the SCI report periodicity 225, the second UE 115-b may apply the SCI report periodicity 225 to a data channel. The first UE 115-a may transmit a data packet 240 to the second UE 115-b. The second UE 115-b may generate a CSI report 235 and transmit it to the first UE 115-a based at least in part on receiving the data packet 240 (or based on receiving a DCI activation, for example). The second UE 115-b may then apply the configured CSI report periodicity for sending a next CSI report. The second UE 115-b may continue to apply the configured CSI report periodicity until it expires, is updated, or is triggered to end.

The CSI report 235 may be transmitted after or within feedback of a physical downlink shared channel (PDSCH) HARQ acknowledgement (HARQ-ACK). When a UE 115 receives a downlink transmission (e.g., a PDSCH), it may generate a HARQ-ACK or NACK based on the decodability of the data in the transmission. For example, if the transmission is decodable, the UE 115 may send an ACK. If the data is not decodable, the UE 115 may send a NACK, which means the CRC for the data failed. During the transmissions of the HARQ-ACK, bits can be added that relate to the CSI observed by the UE 115 while decoding the PDSCH. This may be as a function of a demodulation reference signal (DMRS) from the data or from data channel tones.

When the base station 105-a receives the CSI report 235 from the first UE 115-a, the base station 105-a may tack actions to improve future transmissions. For example, the base station 105-a may enhance or change a modulation and coding scheme (MCS), which may include increasing a number of resource blocks used, which may in tern increase the SNR. These changes may lower the probability that the next transmission will fail, and it may also speed up a retransmission of the failed data packet. This makes it more likely that the next transmission of the data packet will pass the CRC.

In some examples, by adjusting the CSI, the number of resource blocks used by the UE 115-a may be further reduced. For example, the base station 105-a may use a very low MCS, which results in a higher number for resources blocks to send the data packet. This may be excessive for a particular application that does not need such a high level of reliability that a higher number of resources blocks provides. Techniques described herein send a CSI with a PDSCH, which may be used in order to adjust resource block allocations to match current channel conditions and applications needs. This flexible approach may increase the spectral efficiency of the entire system and can be extended to sidelink communications. For example, when the first UE 115-a transmits data to the second UE 115-b, using similar idea from the PDSCH from the base station 105-a to the UE 115-a, the second UE 115-b (e.g., the receiving UE) can send feedback (e.g., CSI reports) to the first UE 115-a. The first UE 115-a may use the feedback to adjust the CSI or MCS, for example. The second UE 115-b may send the CSI reports periodically to the first UE 115-a, based on a periodicity indicated to the second UE 115-b.

In some examples, the first UE 115-a may include a flag 230 in the SCI. The flag 230 may be an indication that indicates a presence or an absence of a CSI-RS in a sidelink channel message.

Techniques described herein propose several different ways to transmit CSI report periodicity to a UE 115. For example, the CSI report periodicity may be indicated in a PSCCH, a PDCCH, a RRC, or a DCI. Further, the CSI report may be indicated in a physical sidelink feedback channel (PSFCH) or a MAC-CE. In some examples, a special or dedicated carrier may be used for CSI reports. For example, whenever there is CSI to report, a special carrier may be generated, such as the PSSCH, that is made for sending CSI reports.

Configuring a receiving UE may be based on whether the configuration is performed in the sidelink environment or in the Uu environment. For example, in a sidelink environment, a transmitting UE (e.g., the first UE 115-a) may configure the receiving UE (e.g., the UE 115-b) to transmit PSSCH-based CSI with a certain periodicity. The periodicity of reporting the CSI may be done in RRC or DCI.

As described herein, controlling CSI report periodicity (e.g., based on PSSCH/PDSCH) can allow for robust CSI, avoid overloading a physical uplink control channel (PUCCH) (e.g., in the Uu link) and PSFCH (e.g., in sidelink), and avoid the UE 115 unnecessarily processing a channel quality index (CQI). The techniques described herein may also allow for efficient CSI accusation. For example, the UE 115 may be configured for a high CSI report periodicity for fast fading channel conditions (e.g., the UE 115 may be moving), such that almost all uplink occasions include CSI. In other scenarios, the UE 115 may be configured for a low CSI report periodicity for slow channel fading conditions (e.g., the UE 115 may be stationary or slowly moving), such that few uplink occasions have CSI.

Techniques described herein provide considerations for CSI report periodicity based on the CSI generated from the PDSCH or PSSCH. The periodicity may be configured for semi-persistent scheduling (SPS) (e.g., configured grants (CGs)) in a Uu link. Techniques described herein also provide periodicity configuration in sidelink configured grants or type 1 and type 2, and sidelink modes 1 and 2 for reserved resources. The periodicity may be applied to the sidelink CG types 1 and 2 for the case of CSI carried in MAC-CE, and may change to SCI-2 to accommodate for PSSCH-based CSI or CSI-RS-based CSI.

The techniques described herein improve network efficiency through more efficient utilization of communication resources because the UEs are using appropriate configurations (e.g., MCS) based on CSI reports. This may reduce interference, reduce retransmissions, and reduce power consumption leading to a longer battery life due to less retransmissions. The described techniques may also improve communication reliability and reduce latency.

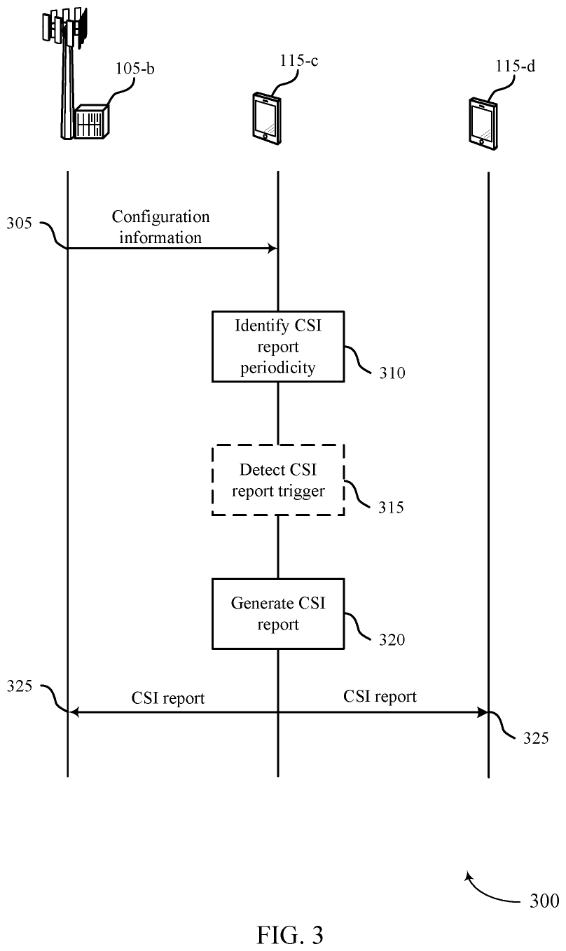

FIG. 3 illustrates an example of a process flow 300 that supports considerations of data channel-based CSI periodicity in accordance with aspects of the present disclosure. In some examples, the process flow 300 may implement aspects of wireless communications system 100 or wireless communications system 200. The process flow 300 may include a first UE 115-c and a second UE 115-d, which may be examples of one or more aspects of the UEs 115 as described herein. The process flow 300 may include a base station 105-b, which may be examples of one or more aspects of the base stations 105 as described herein

At 305, the base station 105-b may transmit configuration information to the first UE 115-c. The configuration information may be sent via a control channel, and may relate to communications between the first UE 115-c and another wireless device over one or more reserved resources, such as the base station 105-b or the second UE 115-d. In some examples, the configuration information may include an indication of a CSI report periodicity. The configuration information may be sent via an RRC message from the base station 105-b, wherein the CSI report periodicity is a sidelink-based CSI report periodicity. Although FIG. 3 shows an example where the configuration information comes from the base station 105-a, in some examples, the configuration information may be from another UE, such as the second UE 115-d. In such an example, the indication of the CSI report periodicity may be transmitted via a sidelink control channel, wherein the CSI report periodicity is a sidelink-based CSI report periodicity. In some examples, the first UE 115-c may receive a configured grant message that identifies resources for sidelink transmissions, wherein the indication of the CSI report periodicity is indicated in the configured grant message.

In some examples, the CSI report periodicity may be based at least in part on one or more of an application priority level or a quality of service (QoS) value of a data channel. In other examples, the first UE 115-c may receive a configuration of an application priority level associated with the CSI report periodicity in an RRC message or a DCI message.

At 310, the first UE 115-c may identify the CSI report periodicity from the configuration information. In some examples, identifying the indication of the CSI report periodicity includes identifying the CSI report periodicity as a sidelink-based CSI report periodicity which is in terms of sidelink shared channel occasions.

At 315, the first UE 115-c may detect an event that triggers a CSI report. The trigger may start the period of CSI reporting. In some examples, the first UE 115-c may apply the CSI report periodicity upon an occurrence of a trigger. In some examples, the trigger may include the first UE 115-c receiving a configured grant. In other examples, the trigger may include a start of a time slot reservation, receipt of a downlink SPS, a DCI activation, or a DCI reactivation.

At 320, the first UE 115-c may generate a CSI report for a data channel. The CSI report may be based on one or more data packet transmissions over the data channel. At 325, the first UE 115-c may transmit the CSI report to the transmitting device, which may be the base station 105-b or the second UE 115-d.

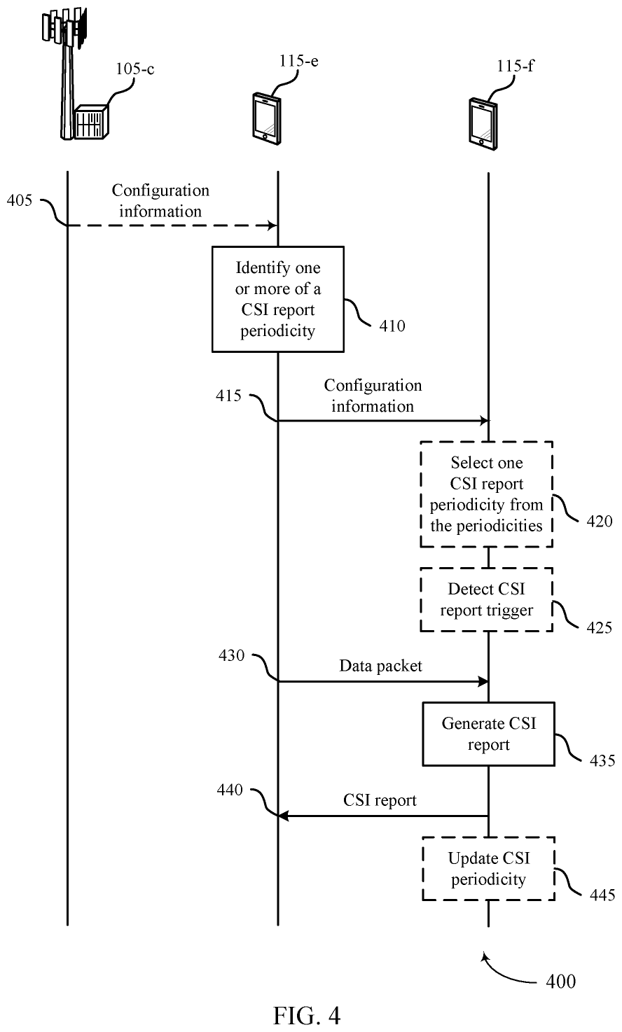

FIG. 4 illustrates an example of a process flow 400 that supports considerations of data channel-based CSI periodicity in accordance with aspects of the present disclosure. In some examples, the process flow 400 may implement aspects of wireless communications system 100 or wireless communications system 200. The process flow 400 may include a transmitting UE 115-e and a receiving UE 115-f, which may be examples of one or more aspects of the UEs 115 as described herein. The process flow 400 may include a base station 105-c, which may be examples of one or more aspects of the base stations 105 as described herein.

At 405, the base station 105-c may optionally transmit configuration information to the transmitting UE 115-e. The configuration information may be sent via a control channel, and may relate to communications between the transmitting UE 115-e and another wireless device over one or more reserved resources, such as the base station 105-c or the receiving UE 115-f In some examples, the configuration information may include an indication of a CSI report periodicity. The configuration information may be sent via an RRC message from the base station 105-c, wherein the CSI report periodicity is a sidelink-based CSI report periodicity. Although FIG. 4 shows an example where the configuration information comes from the base station 105-c, in some examples, the configuration information may be from another UE, such as the receiving UE 115-f, or generated by the transmitting UE 115-e itself.

In some examples, the CSI report periodicity may be based at least in part on one or more of an application priority level or a QoS value of a data channel. In other examples, the transmitting UE 115-e may receive a configuration of an application priority level associated with the CSI report periodicity in an RRC message or a DCI message. In some examples, the CSI report periodicity may include a plurality of possible CSI report periodicities that may be used. The different CSI report periodicities may be determined based on moving speeds of the receiving UE (e.g., the receiving UE 115-f in FIG. 4), a history of the receiving UE, a prediction of the channel conditions, a history of the channel conditions, or an application running on the UE, for example.

At 410, the transmitting UE 115-e may identify the one or more CSI report periodicities from the configuration information. In some examples, identifying the indication of the CSI report periodicities may include identifying the CSI report periodicity as a sidelink-based CSI report periodicity which is in terms of sidelink shared channel occasions.

At 415, the transmitting UE 115-e may transmit the configuration information to the receiving UE 115-f. The configuration information may include an indication the one or more CSI report periodicities. In some examples, the configuration information may also, or alternatively, include an indication that indicates a presence or an absence of a CSI-RS in a sidelink channel message.

At 415, the transmitting UE 115-e may detect an event that triggers a CSI report. The trigger may start the period of CSI reporting. In some examples, the transmitting UE 115-e may apply the CSI report periodicity upon an occurrence of a trigger. In some examples, the trigger may include the transmitting UE 115-e receiving a configured grant. In other examples, the trigger may include a start of a time slot reservation, receipt of a downlink SPS, a DCI activation, or a DCI reactivation.

At 420, if the configuration information indicated a plurality of CSI report periodicities, the transmitting UE may select one of the pluralities of CSI report periodicities to apply. In some examples, selecting the CSI report periodicity from the plurality of CSI report periodicities may be based at least in part on one or more parameters. The one or more parameters include a number of NACK events, a number of ACK events, a change in a data channel characteristic, and a processing load of the receiving UE 115-f or the transmitting UE 115-c. Although FIG. 4 shows that the receiving UE 115-f selects the CSI report periodicity, in some examples the transmitting UE 115-e selects the CSI report periodicity and informs the receiving UE 115-f of the selection.

At 425, the receiving UE 115-f may detect an event that triggers a CSI report. The trigger may start the period of CSI reporting. In some examples, the receiving UE 115-f may apply the CSI report periodicity upon an occurrence of a trigger. In some examples, the trigger may include the receiving UE 115-f receiving a configured grant. In other examples, the trigger may include a start of a time slot reservation, receipt of a downlink SPS, a DCI activation, or a DCI reactivation.

At 430, the transmitting UE 115-d may transmit one or more data packets to the receiving UE 115-f over a data channel, which may be a sidelink data channel. The receiving UE 115-f may attempt to decode the data packets. The receiving UE 115-f may either be able to decode the one or more data packets and will send an ACK, or will not be able to decode at least part of one of the one or more data packets and will send a NACK for at least the undecoded data packet.

Although FIG. 4 illustrates an example where the detection of the CSI report trigger occurs before the receiving UE 115-f receives one or more data packets at 430, the detection of the CSI report trigger at 425 may occur after the receiving UE 115-f receives the data packets.

At 435, the receiving UE 115-f may generate a CSI report for a data channel. The CSI report may be based on one or more data packet transmissions over the data channel. At 440, the receiving UE 115-f may transmit the CSI report to the transmitting UE 115-e.

At 445, the receiving UE 115-f may update the CSI report periodicity. The updated CSI report periodicity may be based on the receiving UE 115-f choosing a different CSI report periodicity from the plurality of CSI report periodicities. In other examples, the CSI report periodicity may be based on the receiving UE 115-f receiving an updated CSI report periodicity from the transmitting UE 115-e. In other examples, the CSI report periodicity may be updated based on changing channel conditions. For example, the CSI report periodicity may be updated according to traffic statistics over the data channel, a change in a data channel characteristic, a rate of change of data channel characteristics of the data channel, a sequence of NACK events, a sequence of ACK events, or a function based at least in part on a number of NACKs.

In some examples, the receiving UE 115-f may receive, from the transmitting UE 115-e, an indication of an updated CSI report periodicity via the control channel, wherein updating the CSI report periodicity is based at least in part on the indication of the updated CSI report periodicity.

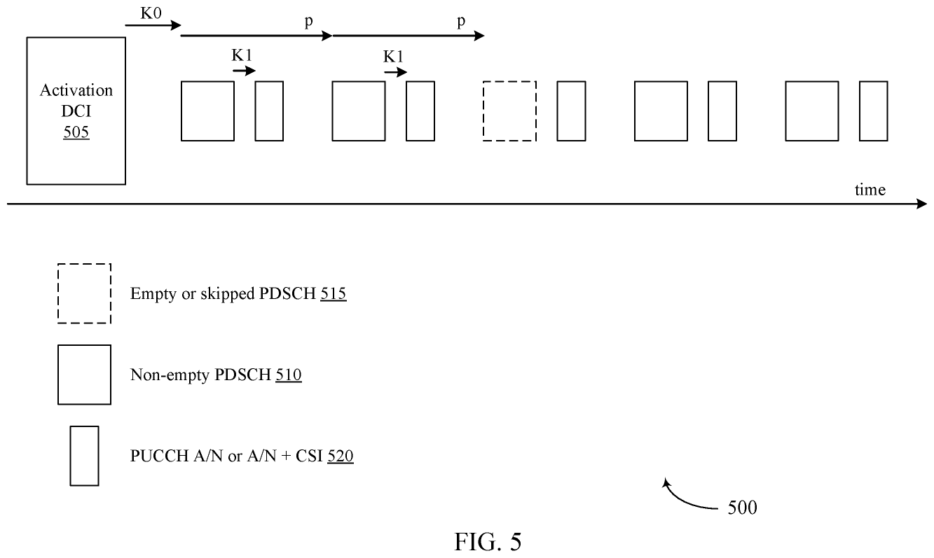

FIG. 5 illustrates an example of a timing diagram 500 that supports considerations of data channel-based CSI periodicity in accordance with aspects of the present disclosure. In some examples, the timing diagram 500 may be implemented in aspects of the wireless communications system 100 or the wireless communications system 200.

The timing diagram 500 illustrates an example SPS PDSCH configuration. An SPS PDSCH configuration may be configured with a periodicity p, which defines the time between two SPS PDSCH occasions, and a parameter K1 which specifies the PUCCH grant time in time slots to send HARQ-ACK after receiving the PDSCH. The PUCCH may be in two stages for ACK/NACK and CSI.

A base station can configure multiple indexes, an a PDSCH index may present as in the example of FIG. 5. At certain times, the base station may activate one or more of SPS PDSCH configuration indexes. Once an activation DCI 505 is received at a UE, after p is configured in RRC as part of a time domain resource (TDR) allocation, the base station may also configure K0. A UE may check the RRC configuration to identify a TDR index. From the TDR information or configuration, the UE may determine K0. After receiving the DCI after the time K0, the first PDSCH occasion may be received, which may be a non-empty PDSCH 510, and then K1 may be explicitly configured by the base station in the DCI. K1 may be the time between receiving the PDSCH 510 and generating a HARQ-ACK 520 for the PDSCH. In some examples, for the HARQ-ACK 520, the UE will transmit an ACK/NACK or an ACK/NACK with CSI. This may be determined by the CP. In some examples, the PDSCH is an empty or skipped PDSCH 515.

Two stages for CSI and ACK/NACK may be used. For example, there may be an accumulation of HARQ-ACK and CSI, so the two stages feature may be enabled for some events. For example, there may be no need to send CSI when all the data packets are properly decoded an the HARQ would be an ACK. Alternatively, if some of the data packets were not decodable, then sending CSI along with the NACK may improve retransmission. When there is an accumulation of ACK or NACK with CSI, the base station may not be able to determine the size of the CSI unless it knows what was ACKed and what was NACKed.

This technique provides a two-stage feedback on PUCCH. The feedback may be at different times or may be at the same time but over different sets of resource blocks. In some examples, the information in the two-stage feedback is separately encoded and decodable. Once the base station knows what was ACKed and what was NACKed, it can determine the payload size of the CSI.

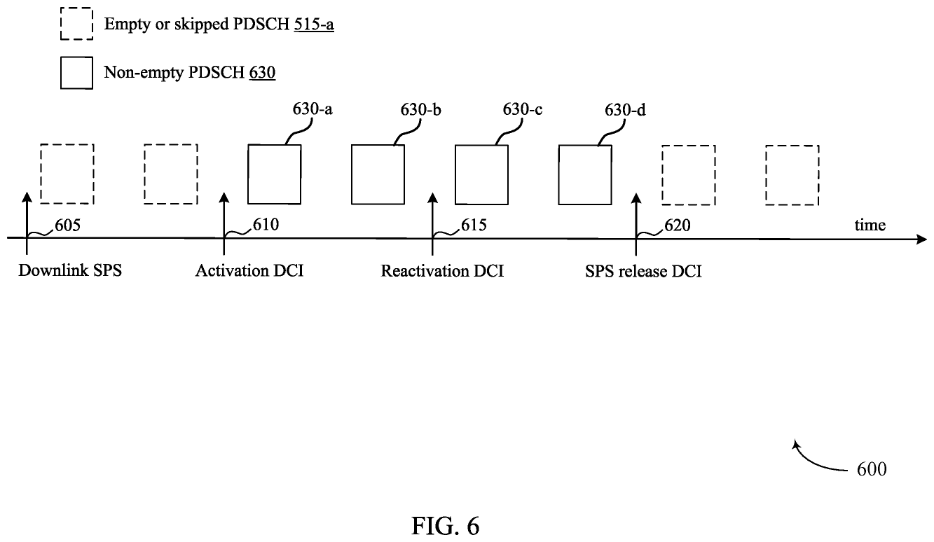

FIG. 6 illustrates an example of a timing diagram 600 that supports considerations of data channel-based CSI periodicity in accordance with aspects of the present disclosure. In some examples, the timing diagram 600 may be implemented in aspects of the wireless communications system 100 or the wireless communications system 200.

In some examples, an RRC configures the SPS periodicity (e.g., downlink SPS 605) and HARQ-ACK feedback resources. A base station may use SPS activation DCI 610 to activate a certain configured SPS. In the activation DCI 610, the base station may indicate transmission parameters such as MCS, resource block allocation, or antenna ports of the SPS transmission, for example. The base station may use SPS reactivation DCI 615 to change the transmission parameters. The base station may deactivate a configured SPS using an SPS release DCI 620.

In other words, the RRC configures the SPS periodicity and also configures the HARQ-ACK feedback resources. In some examples, the base station may explicitly signal the resources allocated in the RRC (e.g., the size, the time/frequency of the allocated resources, a timing itself, for example).

In some examples, the base station may send the reactivation DCI 615, which reconfigures some parameters and may enable the base station to send the SPS release DCI 620 when there is no further data to send or when the base station no longer monitors the PUSCH.

Although FIG. 6 illustrates an SPS configuration, the techniques described herein may be extended to configured grants. Configured grants (e.g., for uplink or sidelink) may be similar to SPS, but have two different types. In type 1, all of the resources are activated and configured using RRC, so there is no DCI activation. In type 2, activation DCI is present. For sidelink, the same concept may be used. The configured grants may be configured by base station, even though the transmissions are between two UEs in sidelink. Configured grants may be used in a mode 1 operation or in a mode 1 resource allocation, which are configured by the base station. The base station may still transmit DCI, and the DCI may include a configuration of the configured grants. In sidelink, after the transmissions, there may be some time for retransmissions, which may be configured by the base station using DCI.

For the downlink SPS 605, the UE may not monitor these SPS occasions because the SPS configuration is not yet active. Once the UE receives the activation DCI 610, the UE may start to monitor the SPS occasions and subsequent SPS occasions following the parameters indicated in the activation DCI 610. Once the UE receives the reactivation DCI 615, the UE may start to monitor this and subsequent SPS occasions following the new parameters indicated in the reactivation DCI. Upon receipt of the SPS release DCI 620, the UE may stop monitoring this SPS occasion and subsequent SPS occasions because the SPS release DCI is received.

For sidelink configured grant types 1 and 2, the base station may include the PSSCH-based CSI report periodicity as part of SL configured grant types 1 and 2. The CSI report periodicity may be measured in terms of PSSCH occasions. For example, if the CSI report periodicity is two, the receiving UE will transmit a CSI report only after two PSSCH occasions have occurred. For example, once the activation DCI 610 has been received, two non-empty PDSCH 630 occasions happen. The receiving UE will not send a CSI report after a first PDSCH 630-a, but will send a CSI report after a second PDSCH 630-b. The receiving UE again does not send a CSI report after a third PDSCH 630-c, but will after a fourth PDSCH 630-d. In other examples, other CSI report periodicities may be defined.

In some examples, configured grants may be configured through RRC. That is, the PSSCH in configured grant types 1 and 2 CSI report periodicity can be RRC configured.

In some examples, the receiving UE may not be aware of reserved resources (for example, SPS or configured grant resources). As such, the transmitting UE may indicate the SPS information to the receiving UE so that the receiving UE may apply the CP. A difference between sidelink environments and Uu environments is that in Uu environments, the receiver side may know the SPS and uses it to decode received information. In sidelink, only the transmitting UE knows the configured grant and the receiver UE does not know the configured grant. As such, the transmitting UE (or even the base station if it is in coverage of the receiving UE), sends the configured grant information to the receiving UE.

In activation sidelink configured grant type 2 DCI, which activates one or more configured grant indices, the base station may change the CSI report periodicity based on traffic statistics or how fast the channel is changing (e.g., based on prior transmissions). Techniques described herein may change the activation DCI 610 by adding one or more bits related to the periodicity of the configured grant.

The techniques described herein may also be applied to a Uu link. For example, the RRC may configure the SPS periodicity and the feedback resources.

In some examples, the CSI report periodicity may be modified or updated in the reactivation DCI 615. This modification may be in response to a sequence of NACK events or a change in channel characteristics (e.g., these may be measured from the SRS or measurements at the base station). In some examples, the CSI report periodicity may be updated according to traffic statistics over the data channel, a change in a data channel characteristic, a rate of change of data channel characteristics of the data channel, a sequence of NACK events, a sequence of ACK events, or a function based on a number of NACKs. In this example, the CSI report periodicity may be modified based on explicit signaling (e.g., explicitly signaled in the reactivation DCI 615). This may be a Uu transmission for uplink or downlink (e.g., there is some relation between the base station and the UE).

In some examples, the base station may configure the PSSCH-based CSI report periodicity while configuring a resource pool. When the configured grant is triggered, the CSI report periodicity may be applied. In some examples, multiple CSI report periodicities may be configured, and one of them may be selected in SCI-1 or SCI-2 by the transmitting UE. In some examples, there may be one or more CSI report periodicities associated with a resource pool. The transmitting UE may select one of them. The transmitting UE may select one of the CSI report periodicities based on channel conditions (e.g., quickly fading or not), whether the receiving UE may be able to perform a certain number of CSI transmissions (e.g., the receiving UE has limited processing power available, a number of observed NACKs, channel changes, the ability of the receiving UE to perform CSI (e.g., the receiving UE may be engaged in many other tasks. In some examples, the selection may be at least partially based on recommendations from the receiving UE.

As described herein, the techniques related to the configured grant may apply to the Uu SPS between a base station and a UE. The periodicity may be measured in terms of PDSCH occasions in such examples.

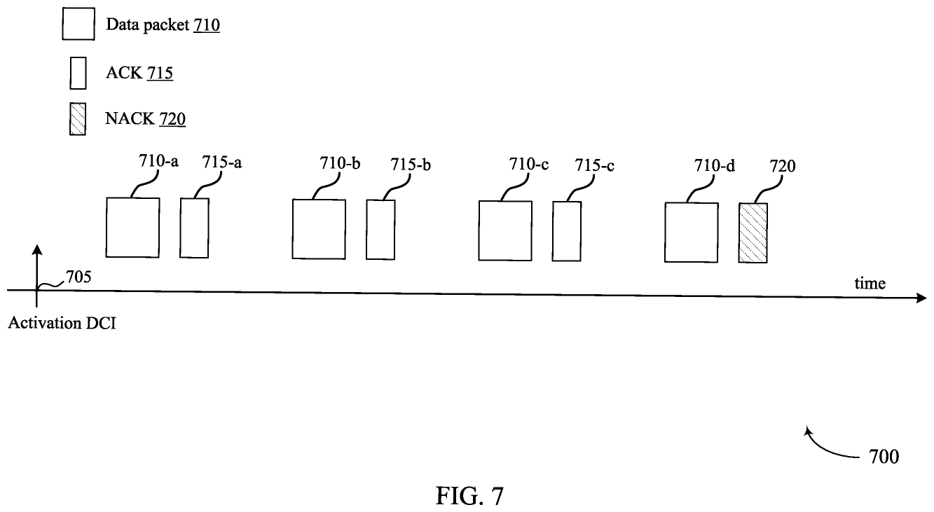

FIG. 7 illustrates an example of a timing diagram 700 that supports considerations of data channel-based CSI periodicity in accordance with aspects of the present disclosure. In some examples, the timing diagram 600 may be implemented in aspects of the wireless communications system 100 or the wireless communications system 200.

The CSI report periodicity may be changed, without explicit signaling, based on observed NACKs since the start of a DCI activation 705. For example, in sidelink configured grant type 1, the DCI activation 705 may be done through RRC, and the same ideas may be applied starting from the configured grant activation.

For example, the resources (e.g., configured grant or SPS) may be configured with a CSI report periodicity of X. After every 2 NACKs, the CSI report periodicity may be reduced to X-F(#NACKs,#ACK) where F(#NACKs,#ACK) could be predetermined or RRC configured. For example, F(#NACKs,#ACK) may be represented by Equation (1):

$$F ( \# NACK s , \# ACK ) = {α}_{1} \cdot ceil ( \frac{\# of NACKs}{Y} ) - {α}_{2} \cdot ceil ( \frac{\# of ACKs}{Y} ) \qquad ( 1 )$$

Y can be a configured integer, and α₁ and α₂ can be preconfigured to adjust the increase or decrease rates.

For example, if the receiving UE begins to count at the activation DCI 705, or from a certain transmission window, the UE may count how many ACKs or NACKs it has. In this example, data packets 710-a, 710-b, and 710-c are properly decoded, and so the receiving UE has three ACKs 715-a, 715-b, and 715-c (collectively referred to herein as ACKs 715). However, the fourth data packet 710-d is not properly decoded, and the UE has a NACK 720.

In this example, after 3 ACK 715, the receiving UE realizes that the channel conditions are good, so it lowers the CSI report periodicity. In some examples, there may be a default periodicity or a configured periodicity that can be increased or decreased based on the number of ACKs or the number of NACKs. Even if the receiving UE were intending to send a CSI report again, a change in the NACKs or ACKs may alter the periodicity. This technique may provide for a dynamic and responsive CSI report periodicity.

In some examples, Y may be a window of occasions, or as the number of NACKs or ACKs. The number of ACKs and NACKs could be observed from a starting point (e.g., activation of DCI at activation DCI 705) up until an end, such as a release or DCI deactivation. For example, a trigger to start counting could include activation DCI, activation of configured grants or SPS, or RRC triggering. Some examples of deactivation could include an indication such as SPS release or DCI release.

In some examples, techniques are described regarding sidelink dynamic grants on modes 1 and 2. In some examples, a transmitting UE may be able to reserve up to two future retransmissions for the same transmission block. Some examples may include mini-slots designs and reservations of mini-slots or an increase in the reservation period to be greater than two (e.g., super slots and repetition could require more than two reservations). For sidelink mode 2, the UE may be able to reserve multiple mini-slots or slots for transmissions of transport blocks.

Techniques described herein may enable a base station to configure the CSI report periodicity while configuring the resource pool, where once a reservation with multiple mini-slots or slots start, the CSI report periodicity is applied. The transmitting UE may indicate the CSI report periodicity of PSSCH-based CSI in SCI-1 or SCI-2 reservation of resources. In another example, the transmitting UE may indicate the periodicity of the PSSCH-based CSI in SCI-1 or SCI-2. In such an example, the first or starting transmission SCIs may be used for such configurations.

In some examples, the CSI report periodicity may be associated with a quality of service or a priority in the Uu link. Assuming a priority Pₖ from a set of priority levels {P₁, P₂, . . . , P_{M}}, wherein there are M priority levels, Tₖ may be an assigned priority, where Tₖ is the PDSCH-based CSI report periodicity. In some examples, the relationship between Pₖ and Tₖ may be RRC configured. Each Pₖ may have L values of Tₖ. One of the L values could be signaled in a MAC-CE or DCI. This technique may apply to a Uu link where traffic priority of an SPS configuration may be sent by the RRC and cannot be modified by the DCI. This technique may be extended to sidelink if the configured grant in sidelink uses a fixed priority per RRC. For example, if the configured grant transmission block priority is not dynamic and the SCI cannot change the priority level.

Regarding configured grant types 1 and 2 and CSI carried in MAC-CEs, an indication field may be introduced. The indication field may be a one-bit flag in SCI-2 that indicates whether the triggered CSI report (on MAC-CE) is CSI-RS based or PSSCH/PSCCH based. Since CSI can be generated from PSSCH, the receiving UE may have to know if the CSI is generated from CSI-RS or PSSCH. The transmitting UE may add a 1-bit flag in SCI-2 (which may be referred to as a CSI Source Flag). The field may be “0” for CSI-RS (which indicates that there are CSI-RS resources in the current PSSCH) or “1” for PSSCH (which indicates that there are no CSI-RS resources and all PSSCH is used for data).

To apply the same periodicity on the current sidelink configured grant types 1 and 2, at the X^{th} PSSCH occasion (in SPS/configured grant), the transmitting UE may trigger CSI report using a “CSI request” field in the corresponding SCI format. The receiving UE may send the CSI in the MAC-CE in the next available PSSCH resource.

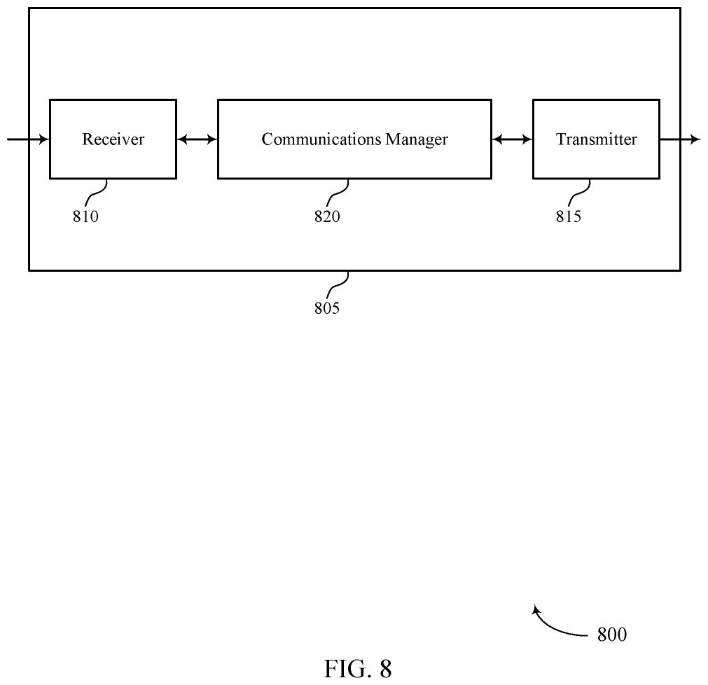

FIG. 8 shows a block diagram 800 of a device 805 that supports considerations of data channel-based CSI periodicity in accordance with aspects of the present disclosure. The device 805 may be an example of aspects of a UE 115 as described herein. The device 805 may include a receiver 810, a transmitter 815, and a communications manager 820. The device 805 may also include at least one processor. Each of these components may be in communication with one another (e.g., via one or more buses).

The receiver 810 may provide a means for receiving information such as packets, user data, control information, or any combination thereof associated with various information channels (e.g., control channels, data channels, information channels related to considerations of data channel-based CSI periodicity). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to considerations of data channel-based CSI periodicity). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of considerations of data channel-based CSI periodicity as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software) executed by a processor. If implemented in code executed by a processor, the functions of the communications manager 820, the receiver 810, the transmitter 815, or various combinations or components thereof may be performed by a general-purpose processor, a DSP, a central processing unit (CPU), a graphics processing unit (GPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. For example, the communications manager 820 may be configured as or otherwise support a means for receiving, at the UE and via a control channel, configuration information for communications between the UE and a wireless device over one or more reserved resources. The communications manager 820 may be configured as or otherwise support a means for identifying, from the configuration information, an indication of a CSI report periodicity. The communications manager 820 may be configured as or otherwise support a means for transmitting a CSI report for a data channel in accordance with the CSI report periodicity.

Additionally, or alternatively, the communications manager 820 may support wireless communication at a first wireless device in accordance with examples as disclosed herein. For example, the communications manager 820 may be configured as or otherwise support a means for generating a sidelink control information message including an indication indicating a presence or an absence of a CSI reference signal in a sidelink channel message. The communications manager 820 may be configured as or otherwise support a means for transmitting the sidelink control information message to a second wireless device.

Additionally, or alternatively, the communications manager 820 may support wireless communication at a first wireless device in accordance with examples as disclosed herein. For example, the communications manager 820 may be configured as or otherwise support a means for receiving, from a second wireless device, a sidelink control information message including an indication indicating a presence or an absence of a CSI reference signal in a sidelink channel message. The communications manager 820 may be configured as or otherwise support a means for generating a CSI report for a data channel based on the indication. The communications manager 820 may be configured as or otherwise support a means for transmitting the CSI report to the second wireless device.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, and more efficient utilization of communication resources.

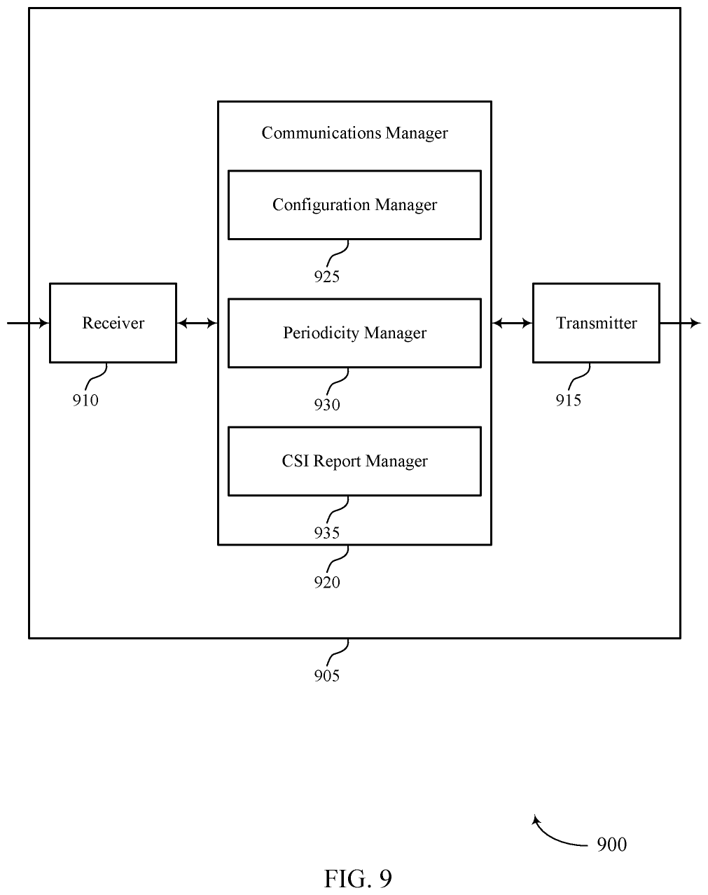

FIG. 9 shows a block diagram 900 of a device 905 that supports considerations of data channel-based CSI periodicity in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to considerations of data channel-based CSI periodicity). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to considerations of data channel-based CSI periodicity). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of considerations of data channel-based CSI periodicity as described herein. For example, the communications manager 920 may include a configuration manager 925, a periodicity manager 930, a CSI report manager 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a UE in accordance with examples as disclosed herein. The configuration manager 925 may be configured as or otherwise support a means for receiving, at the UE and via a control channel, configuration information for communications between the UE and a wireless device over one or more reserved resources. The periodicity manager 930 may be configured as or otherwise support a means for identifying, from the configuration information, an indication of a CSI report periodicity. The CSI report manager 935 may be configured as or otherwise support a means for transmitting a CSI report for a data channel in accordance with the CSI report periodicity.

Additionally, or alternatively, the communications manager 920 may support wireless communication at a first wireless device in accordance with examples as disclosed herein. The CSI report manager 935 may be configured as or otherwise support a means for generating a sidelink control information message including an indication indicating a presence or an absence of a CSI reference signal in a sidelink channel message. The configuration manager 925 may be configured as or otherwise support a means for transmitting the sidelink control information message to a second wireless device.

Additionally, or alternatively, the communications manager 920 may support wireless communication at a first wireless device in accordance with examples as disclosed herein. The configuration manager 925 may be configured as or otherwise support a means for receiving, from a second wireless device, a sidelink control information message including an indication indicating a presence or an absence of a CSI reference signal in a sidelink channel message. The CSI report manager 935 may be configured as or otherwise support a means for generating a CSI report for a data channel based on the indication. The CSI report manager 935 may be configured as or otherwise support a means for transmitting the CSI report to the second wireless device.

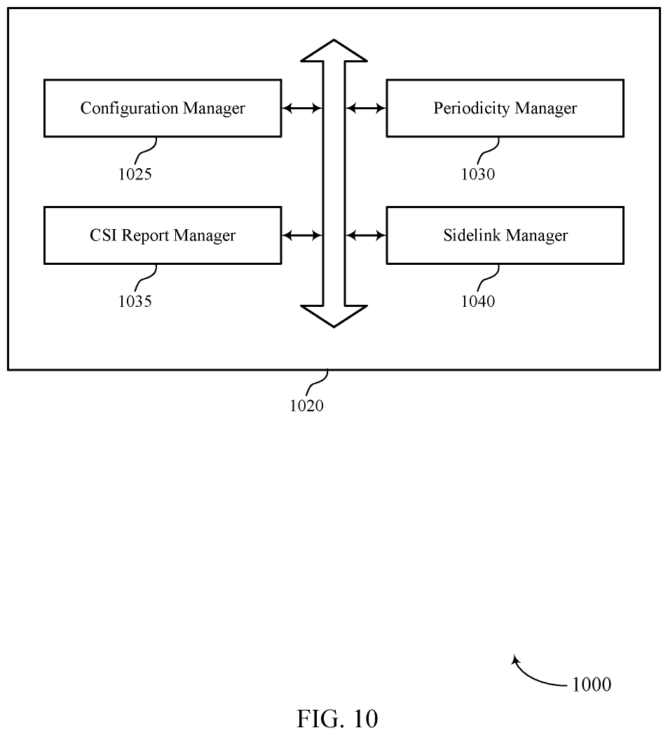

FIG. 10 shows a block diagram 1000 of a communications manager 1020 that supports considerations of data channel-based CSI periodicity in accordance with aspects of the present disclosure. The communications manager 1020 may be an example of aspects of a communications manager 820, a communications manager 920, or both, as described herein. The communications manager 1020, or various components thereof, may be an example of means for performing various aspects of considerations of data channel-based CSI periodicity as described herein. For example, the communications manager 1020 may include a configuration manager 1025, a periodicity manager 1030, a CSI report manager 1035, a sidelink manager 1040, or any combination thereof. Each of these components may communicate, directly or indirectly, with one another (e.g., via one or more buses).

The communications manager 1020 may support wireless communication at a UE in accordance with examples as disclosed herein. The configuration manager 1025 may be configured as or otherwise support a means for receiving, at the UE and via a control channel, configuration information for communications between the UE and a wireless device over one or more reserved resources. The periodicity manager 1030 may be configured as or otherwise support a means for identifying, from the configuration information, an indication of a CSI report periodicity. The CSI report manager 1035 may be configured as or otherwise support a means for transmitting a CSI report for a data channel in accordance with the CSI report periodicity.

In some examples, to support identifying the indication of the CSI report periodicity, the sidelink manager 1040 may be configured as or otherwise support a means for identifying the CSI report periodicity as a sidelink-based CSI report periodicity which is in terms of sidelink shared channel occasions.

In some examples, to support receiving the configuration information, the configuration manager 1025 may be configured as or otherwise support a means for receiving the indication of the CSI report periodicity via a radio resource control message from the wireless device, where the CSI report periodicity is a sidelink-based CSI report periodicity, and the wireless device is a base station.

In some examples, to support receiving the configuration information, the sidelink manager 1040 may be configured as or otherwise support a means for receiving the indication of the CSI report periodicity via a sidelink control channel, where the CSI report periodicity is a sidelink-based CSI report periodicity.

In some examples, the periodicity manager 1030 may be configured as or otherwise support a means for updating the CSI report periodicity according to traffic statistics over the data channel, a change in a data channel characteristic, a rate of change of data channel characteristics of the data channel, a sequence of negative acknowledgement events, a sequence of acknowledgement events, or a function based on a number of negative acknowledgements.

In some examples, the periodicity manager 1030 may be configured as or otherwise support a means for receiving, from the wireless device, an indication of an updated CSI report periodicity via the control channel, where updating the CSI report periodicity is based on the indication of the updated CSI report periodicity, and where the wireless device is a base station.

In some examples, the periodicity manager 1030 may be configured as or otherwise support a means for receiving a reactivation downlink control information message, where updating the CSI report periodicity is based on the reactivation downlink control information message.

In some examples, the configuration manager 1025 may be configured as or otherwise support a means for receiving a configured grant message that identifies resources for sidelink transmissions, where the indication of the CSI report periodicity is indicated in the configured grant message.

In some examples, the periodicity manager 1030 may be configured as or otherwise support a means for applying the CSI report periodicity upon an occurrence of a trigger.

In some examples, the trigger includes receiving a configured grant or a start of a time slot reservation.

In some examples, to support identifying the indication of the CSI report periodicity, the periodicity manager 1030 may be configured as or otherwise support a means for receiving indications of a set of multiple CSI report periodicities via the control channel. In some examples, to support identifying the indication of the CSI report periodicity, the periodicity manager 1030 may be configured as or otherwise support a means for selecting the CSI report periodicity from the set of multiple CSI report periodicities based on one or more parameters.

In some examples, the one or more parameters include a number of negative acknowledgement events, a number of acknowledgement events, a change in a data channel characteristic, and a processing load of the UE.

In some examples, to support identifying the indication of the CSI report periodicity, the sidelink manager 1040 may be configured as or otherwise support a means for receiving the indication of the CSI report periodicity in a sidelink control information message.

In some examples, the CSI report periodicity is based on one or more of an application priority level or a quality of service value of the data channel.

In some examples, the configuration manager 1025 may be configured as or otherwise support a means for receiving a configuration of an application priority level associated with the CSI report periodicity in a radio resource configuration message or a downlink control information message.

Additionally, or alternatively, the communications manager 1020 may support wireless communication at a first wireless device in accordance with examples as disclosed herein. In some examples, the CSI report manager 1035 may be configured as or otherwise support a means for generating a sidelink control information message including an indication indicating a presence or an absence of a CSI reference signal in a sidelink channel message. In some examples, the configuration manager 1025 may be configured as or otherwise support a means for transmitting the sidelink control information message to a second wireless device.

In some examples, the indication includes a one-bit flag. In some examples, a first value of the one-bit flag indicates that the CSI reference signal is present in the sidelink channel message and a second value of the one-bit flag indicates that the CSI reference signal is absent from the sidelink channel message.

In some examples, to support generating the sidelink control information message, the CSI report manager 1035 may be configured as or otherwise support a means for setting, based on a physical sidelink control channel occasion, a CSI request indicator in the sidelink control information message that indicates to the second wireless device to send a CSI report in a next available physical sidelink control channel resource.

Additionally, or alternatively, the communications manager 1020 may support wireless communication at a first wireless device in accordance with examples as disclosed herein. In some examples, the configuration manager 1025 may be configured as or otherwise support a means for receiving, from a second wireless device, a sidelink control information message including an indication indicating a presence or an absence of a CSI reference signal in a sidelink channel message. In some examples, the CSI report manager 1035 may be configured as or otherwise support a means for generating a CSI report for a data channel based on the indication. In some examples, the CSI report manager 1035 may be configured as or otherwise support a means for transmitting the CSI report to the second wireless device.

In some examples, the indication includes a one-bit flag. In some examples, a first value of the one-bit flag indicates that the CSI reference signal is present in the sidelink channel message and a second value of the one-bit flag indicates that the CSI reference signal is absent from the sidelink channel message.

In some examples, to support receiving the sidelink control information message, the CSI report manager 1035 may be configured as or otherwise support a means for identifying a CSI request indicator in the sidelink control information message that indicates when to transmit the CSI report, where transmitting the CSI report is based on the CSI request indicator.

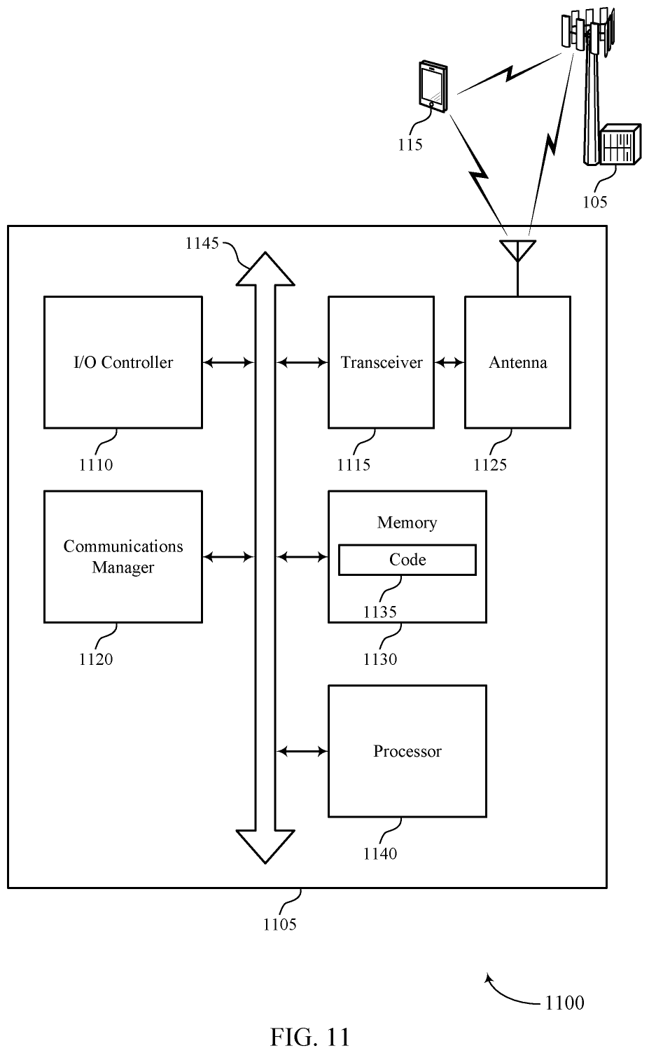

FIG. 11 shows a diagram of a system 1100 including a device 1105 that supports considerations of data channel-based CSI periodicity in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting considerations of data channel-based CSI periodicity). For example, the device 1105 or a component of the device 1105 may include at least one processor 1140 and memory 1130 coupled to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for receiving, at the UE and via a control channel, configuration information for communications between the UE and a wireless device over one or more reserved resources. The communications manager 1120 may be configured as or otherwise support a means for identifying, from the configuration information, an indication of a CSI report periodicity. The communications manager 1120 may be configured as or otherwise support a means for transmitting a CSI report for a data channel in accordance with the CSI report periodicity.

Additionally, or alternatively, the communications manager 1120 may support wireless communication at a first wireless device in accordance with examples as disclosed herein. For example, the communications manager 1120 may be configured as or otherwise support a means for generating a sidelink control information message including an indication indicating a presence or an absence of a CSI reference signal in a sidelink channel message. The communications manager 1120 may be configured as or otherwise support a means for transmitting the sidelink control information message to a second wireless device.

Additionally, or alternatively, the communications manager 1120 may support wireless communication at a first wireless device in accordance with examples as disclosed herein. For example, the communications manager 1120 may be configured as or otherwise support a means for receiving, from a second wireless device, a sidelink control information message including an indication indicating a presence or an absence of a CSI reference signal in a sidelink channel message. The communications manager 1120 may be configured as or otherwise support a means for generating a CSI report for a data channel based on the indication. The communications manager 1120 may be configured as or otherwise support a means for transmitting the CSI report to the second wireless device.

By including or configuring the communications manager 1120 in accordance with examples as described herein, the device 1105 may support techniques for improved communication reliability, reduced latency, improved reliability, improved user experience related to reduced processing, reduced power consumption, and more efficient utilization of communication resources.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of considerations of data channel-based CSI periodicity as described herein, or the processor 1140 and the memory 1130 may be otherwise configured to perform or support such operations.

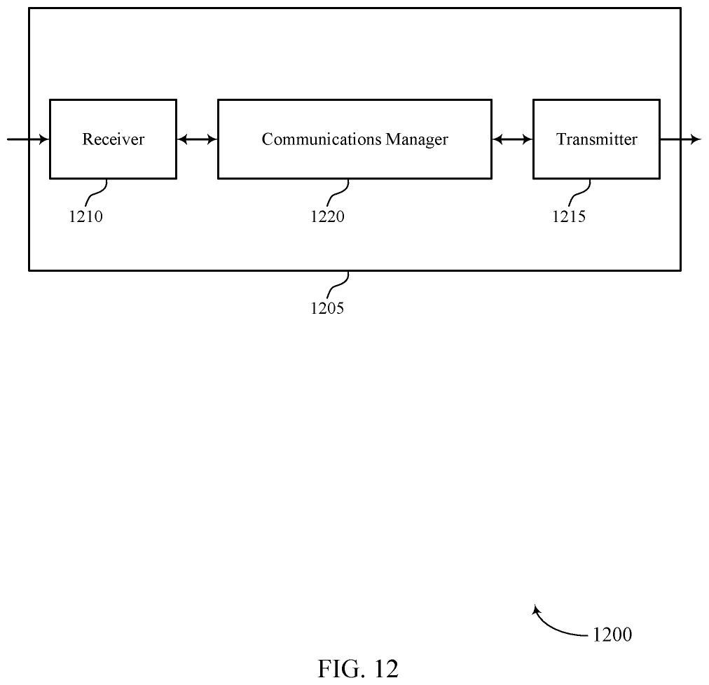

FIG. 12 shows a block diagram 1200 of a device 1205 that supports considerations of data channel-based CSI periodicity in accordance with aspects of the present disclosure. The device 1205 may be an example of aspects of a base station 105 as described herein. The device 1205 may include a receiver 1210, a transmitter 1215, and a communications manager 1220. The device 1205 may also include at least one processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to considerations of data channel-based CSI periodicity). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to considerations of data channel-based CSI periodicity). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of considerations of data channel-based CSI periodicity as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software) executed by a processor. If implemented in code executed by a processor, the functions of the communications manager 1220, the receiver 1210, the transmitter 1215, or various combinations or components thereof may be performed by a general-purpose processor, a DSP, a CPU, a GPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

For example, the communications manager 1220 may be configured as or otherwise support a means for determining one or more CSI report periodicities. The communications manager 1220 may be configured as or otherwise support a means for transmitting, to a UE and via a control channel, configuration information for communications between the UE and a wireless device over one or more reserved resources, where the configuration information includes the one or more CSI report periodicities.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for reduced processing, reduced power consumption, and more efficient utilization of communication resources.

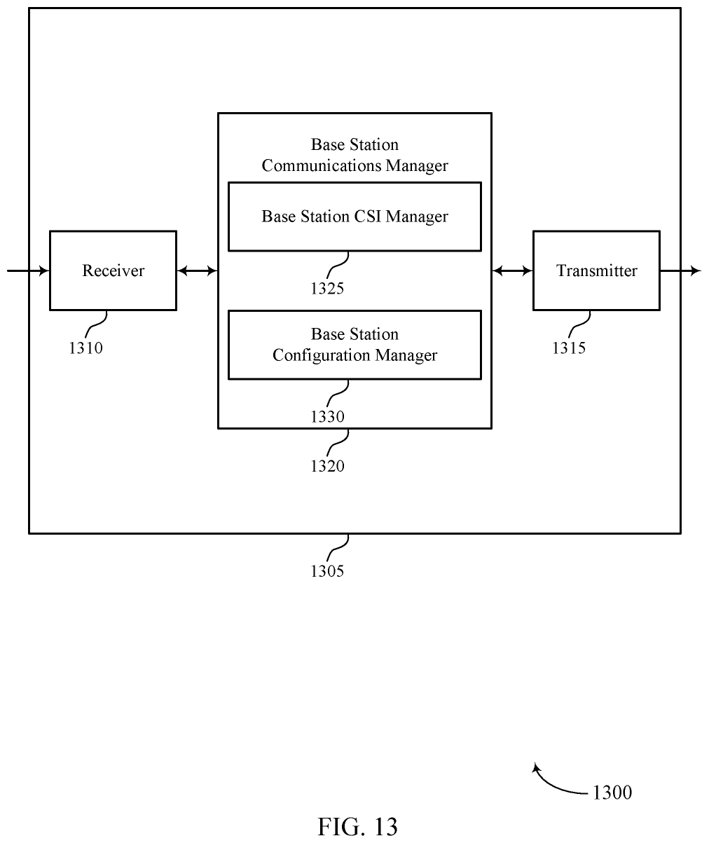

FIG. 13 shows a block diagram 1300 of a device 1305 that supports considerations of data channel-based CSI periodicity in accordance with aspects of the present disclosure. The device 1305 may be an example of aspects of a device 1205 or a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to considerations of data channel-based CSI periodicity). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to considerations of data channel-based CSI periodicity). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of considerations of data channel-based CSI periodicity as described herein. For example, the communications manager 1320 may include a base station CSI manager 1325 a base station configuration manager 1330, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The base station CSI manager 1325 may be configured as or otherwise support a means for determining one or more CSI report periodicities. The base station configuration manager 1330 may be configured as or otherwise support a means for transmitting, to a UE and via a control channel, configuration information for communications between the UE and a wireless device over one or more reserved resources, where the configuration information includes the one or more CSI report periodicities.

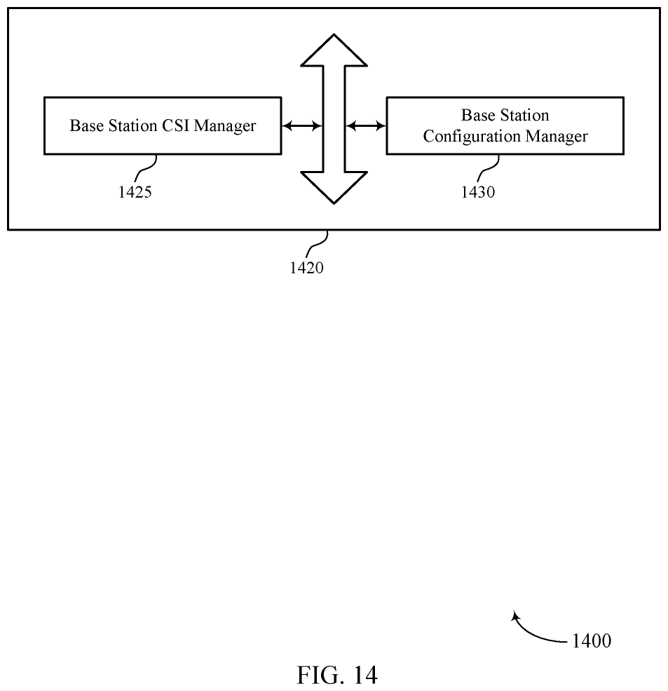

FIG. 14 shows a block diagram 1400 of a communications manager 1420 that supports considerations of data channel-based CSI periodicity in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of considerations of data channel-based CSI periodicity as described herein. For example, the communications manager 1420 may include a base station CSI manager 1425 a base station configuration manager 1430, or any combination thereof. Each of these components may communicate, directly or indirectly, with one another (e.g., via one or more buses).

The base station CSI manager 1425 may be configured as or otherwise support a means for determining one or more CSI report periodicities. The base station configuration manager 1430 may be configured as or otherwise support a means for transmitting, to a UE and via a control channel, configuration information for communications between the UE and a wireless device over one or more reserved resources, where the configuration information includes the one or more CSI report periodicities.

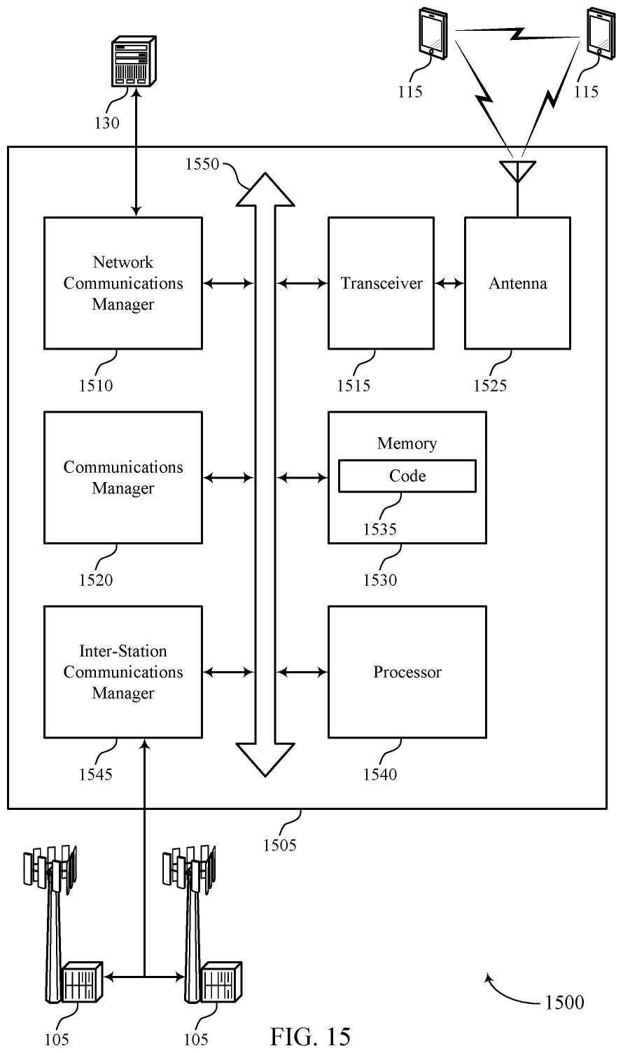

FIG. 15 shows a diagram of a system 1500 including a device 1505 that supports considerations of data channel-based CSI periodicity in accordance with aspects of the present disclosure. The device 1505 may be an example of or include the components of a device 1205, a device 1305, or a base station 105 as described herein. The device 1505 may communicate wirelessly with one or more base stations 105, UEs 115, or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting considerations of data channel-based CSI periodicity). For example, the device 1505 or a component of the device 1505 may include a processor 1540 and memory 1530 coupled to the processor 1540, the processor 1540 and memory 1530 configured to perform various functions described herein.

The inter-station communications manager 1545 may manage communications with other base stations 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between base stations 105.

For example, the communications manager 1520 may be configured as or otherwise support a means for determining one or more CSI report periodicities. The communications manager 1520 may be configured as or otherwise support a means for transmitting, to a UE and via a control channel, configuration information for communications between the UE and a wireless device over one or more reserved resources, where the configuration information includes the one or more CSI report periodicities.

By including or configuring the communications manager 1520 in accordance with examples as described herein, the device 1505 may support techniques for improved communication reliability, reduced latency, improved user experience related to reduced processing, reduced power consumption, and more efficient utilization of communication resources.

The techniques described herein may improve network efficiency through increasing the spectral efficiency of the entire wireless communications system, improve efficient utilization of communication resources, reduce interference, reduce retransmissions by increasing reliability of transmissions, reduce power consumption leading to a longer battery life due to less retransmissions, and improve user experience. The described techniques may also improve communication reliability, improve coordination between devices, reduce latency, and improve flexibility at the UE. The techniques described herein also improve low latency and high reliability for sidelink applications (such as, for example, IIoT, XR, and smart wearables). The techniques described herein provide for robust CSI reporting, reduces overloading of PUCCH (in a Uu link) or overloading in PSFCH (in sidelink), and reduces unnecessary processing of channel quality information at the UE.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of considerations of data channel-based CSI periodicity as described herein, or the processor 1540 and the memory 1530 may be otherwise configured to perform or support such operations.

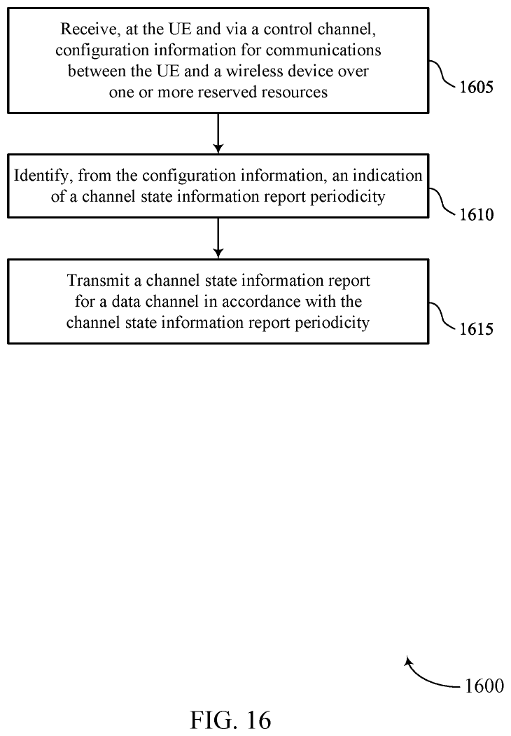

FIG. 16 shows a flowchart illustrating a method 1600 that supports considerations of data channel-based CSI periodicity in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, at the UE and via a control channel, configuration information for communications between the UE and a wireless device over one or more reserved resources. The operations of 1605 may be performed in accordance with examples as disclosed herein. In some examples, aspects of the operations of 1605 may be performed by a configuration manager 1025 as described with reference to FIG. 10.

At 1610, the method may include identifying, from the configuration information, an indication of a CSI report periodicity. The operations of 1610 may be performed in accordance with examples as disclosed herein. In some examples, aspects of the operations of 1610 may be performed by a periodicity manager 1030 as described with reference to FIG. 10.

At 1615, the method may include transmitting a CSI report for a data channel in accordance with the CSI report periodicity. The operations of 1615 may be performed in accordance with examples as disclosed herein. In some examples, aspects of the operations of 1615 may be performed by a CSI report manager 1035 as described with reference to FIG. 10.

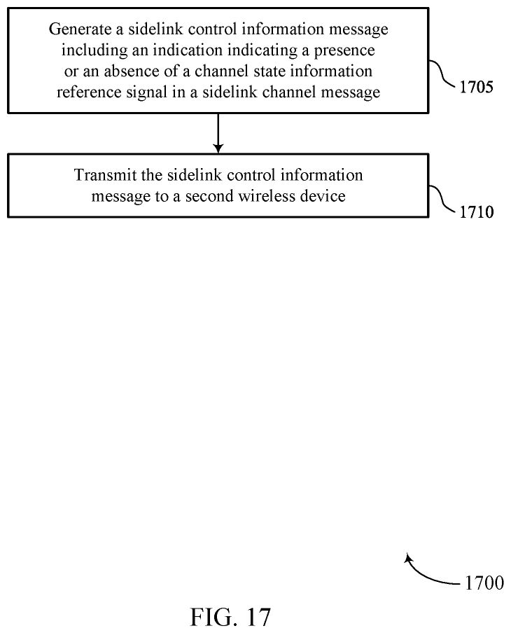

FIG. 17 shows a flowchart illustrating a method 1700 that supports considerations of data channel-based CSI periodicity in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include generating a sidelink control information message including an indication indicating a presence or an absence of a CSI reference signal in a sidelink channel message. The operations of 1705 may be performed in accordance with examples as disclosed herein. In some examples, aspects of the operations of 1705 may be performed by a CSI report manager 1035 as described with reference to FIG. 10.

At 1710, the method may include transmitting the sidelink control information message to a second wireless device. The operations of 1710 may be performed in accordance with examples as disclosed herein. In some examples, aspects of the operations of 1710 may be performed by a configuration manager 1025 as described with reference to FIG. 10.

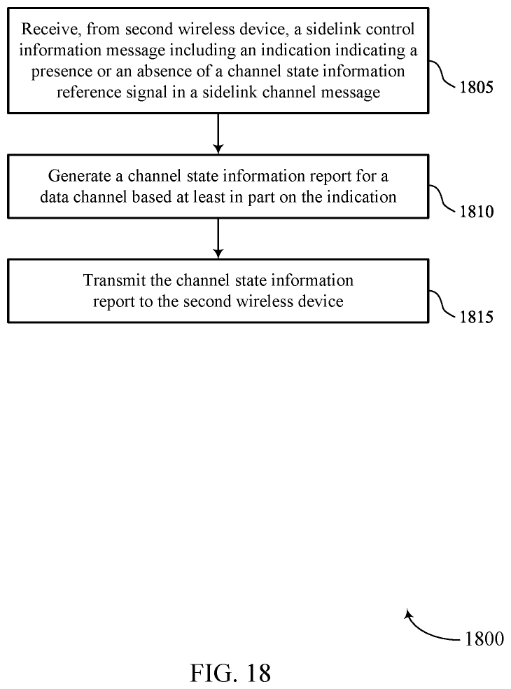

FIG. 18 shows a flowchart illustrating a method 1800 that supports considerations of data channel-based CSI periodicity in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving, from a second wireless device, a sidelink control information message including an indication indicating a presence or an absence of a CSI reference signal in a sidelink channel message. The operations of 1805 may be performed in accordance with examples as disclosed herein. In some examples, aspects of the operations of 1805 may be performed by a configuration manager 1025 as described with reference to FIG. 10.

At 1810, the method may include generating a CSI report for a data channel based on the indication. The operations of 1810 may be performed in accordance with examples as disclosed herein. In some examples, aspects of the operations of 1810 may be performed by a CSI report manager 1035 as described with reference to FIG. 10.

At 1815, the method may include transmitting the CSI report to the second wireless device. The operations of 1815 may be performed in accordance with examples as disclosed herein. In some examples, aspects of the operations of 1815 may be performed by a CSI report manager 1035 as described with reference to FIG. 10.

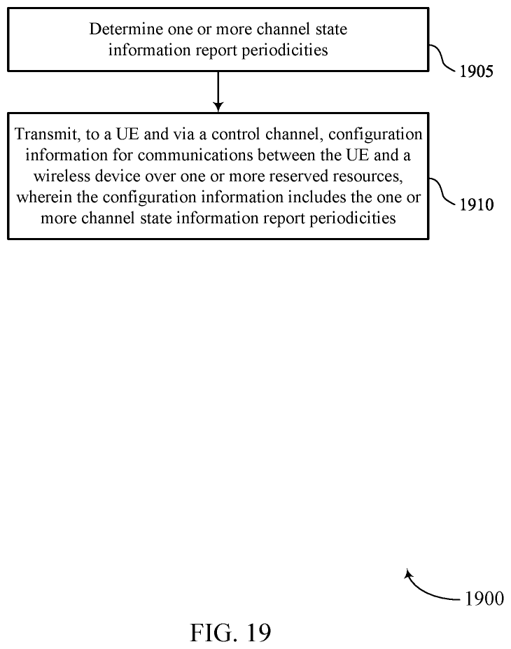

FIG. 19 shows a flowchart illustrating a method 1900 that supports considerations of data channel-based CSI periodicity in accordance with aspects of the present disclosure. The operations of the method 1900 may be implemented by a base station or its components as described herein. For example, the operations of the method 1900 may be performed by a base station 105 as described with reference to FIGS. 1 through 7 and 12 through 15. In some examples, a base station may execute a set of instructions to control the functional elements of the base station to perform the described functions. Additionally, or alternatively, the base station may perform aspects of the described functions using special-purpose hardware.

At 1905, the method may include determining one or more CSI report periodicities. The operations of 1905 may be performed in accordance with examples as disclosed herein. In some examples, aspects of the operations of 1905 may be performed by a base station CSI manager 1425 as described with reference to FIG. 14.

At 1910, the method may include transmitting, to a UE and via a control channel, configuration information for communications between the UE and a wireless device over one or more reserved resources, where the configuration information includes the one or more CSI report periodicities. The operations of 1910 may be performed in accordance with examples as disclosed herein. In some examples, aspects of the operations of 1910 may be performed by a base station configuration manager 1430 as described with reference to FIG. 14.

The following provides an overview of aspects of the present disclosure:

Aspect 1: A method for wireless communication at a UE, comprising: receiving, at the UE and via a control channel, configuration information for communications between the UE and a wireless device over one or more reserved resources; identifying, from the configuration information, an indication of a CSI report periodicity; and transmitting a CSI report for a data channel in accordance with the CSI report periodicity.

Aspect 2: The method of aspect 1, wherein identifying the indication of the CSI report periodicity further comprises: identifying the sidelink-based CSI report periodicity as a sidelink-based CSI report periodicity which is in terms of sidelink shared channel occasions.

Aspect 3: The method of any of aspects 1 through 2, wherein receiving the configuration information further comprises: receiving the indication of the CSI report periodicity via a radio resource control message from the wireless device, wherein the CSI report periodicity is a sidelink-based CSI report periodicity and the wireless device is a base station.

Aspect 4: The method of any of aspects 1 through 3, wherein receiving the configuration information further comprises: receiving the indication of the CSI report periodicity via a sidelink control channel, wherein the CSI report periodicity is a sidelink-based CSI report periodicity.

Aspect 5: The method of any of aspects 1 through 4, further comprising: updating the CSI report periodicity according to traffic statistics over the data channel, a change in a data channel characteristic, a rate of change of data channel characteristics of the data channel, a sequence of negative acknowledgement events, a sequence of acknowledgement events, or a function based at least in part on a number of negative acknowledgements.

Aspect 6: The method of aspect 5, further comprising: receiving, from the wireless device, an indication of an updated CSI report periodicity via the control channel, wherein updating the CSI report periodicity is based at least in part on the indication of the updated CSI report periodicity, and wherein the wireless device is a base station.

Aspect 7: The method of any of aspects 5 through 6, further comprising: receiving a reactivation downlink control information message, wherein updating the CSI report periodicity is based at least in part on the reactivation downlink control information message.

Aspect 8: The method of any of aspects 5 through 7, further comprising: receiving a configured grant message that identifies resources for sidelink transmissions, wherein the indication of the CSI report periodicity is indicated in the configured grant message.

Aspect 9: The method of any of aspects 1 through 8, further comprising: applying the CSI report periodicity upon an occurrence of a trigger.

Aspect 10: The method of aspect 9, wherein the trigger comprises receiving a configured grant or a start of a time slot reservation.

Aspect 11: The method of any of aspects 1 through 10, wherein identifying the indication of the CSI report periodicity further comprises: receiving indications of a plurality of CSI report periodicities via the control channel; and selecting the CSI report periodicity from the plurality of CSI report periodicities based at least in part on one or more parameters.

Aspect 12: The method of aspect 11, wherein the one or more parameters include a number of negative acknowledgement events, a number of acknowledgement events, a change in a data channel characteristic, and a processing load of the UE.

Aspect 13: The method of any of aspects 1 through 12, wherein identifying the indication of the CSI report periodicity further comprises: receiving the indication of the CSI report periodicity in a sidelink control information message.

Aspect 14: The method of any of aspects 1 through 13, wherein the CSI report periodicity is based at least in part on one or more of an application priority level or a quality of service value of the data channel.

Aspect 15: The method of aspect 14, further comprising: receiving a configuration of an application priority level associated with the CSI report periodicity in a radio resource configuration message or a downlink control information message.

Aspect 16: A method for wireless communication at a first wireless device, comprising: generating a sidelink control information message including an indication indicating a presence or an absence of a CSI reference signal in a sidelink channel message; and transmitting the sidelink control information message to a second wireless device.

Aspect 17: The method of aspect 16, wherein the indication comprises a one-bit flag, a first value of the one-bit flag indicates that the CSI reference signal is present in the sidelink channel message and a second value of the one-bit flag indicates that the CSI reference signal is absent from the sidelink channel message.

Aspect 18: The method of any of aspects 16 through 17, wherein generating the sidelink control information message further comprises: setting, based at least in part on a physical sidelink control channel occasion, a CSI request indicator in the sidelink control information message that indicates to the second wireless device to send a CSI report in a next available physical sidelink control channel resource.

Aspect 19: A method for wireless communication at a first wireless device, comprising: receiving, from a second wireless device, a sidelink control information message including an indication indicating a presence or an absence of a CSI reference signal in a sidelink channel message; generating a CSI report for a data channel based at least in part on the indication; and transmitting the CSI report to the second wireless device.

Aspect 20: The method of aspect 19, wherein the indication comprises a one-bit flag, a first value of the one-bit flag indicates that the CSI reference signal is present in the sidelink channel message and a second value of the one-bit flag indicates that the CSI reference signal is absent from the sidelink channel message.

Aspect 21: The method of any of aspects 19 through 20, wherein receiving the sidelink control information message further comprises: identifying a CSI request indicator in the sidelink control information message that indicates when to transmit the CSI report, wherein transmitting the CSI report is based at least in part on the CSI request indicator.

Aspect 22: A method, comprising: determining one or more CSI report periodicities; and transmitting, to a UE and via a control channel, configuration information for communications between the UE and a wireless device over one or more reserved resources, wherein the configuration information includes the one or more CSI report periodicities.

Aspect 23: An apparatus for wireless communication at a UE, comprising a processor; memory coupled with the processor; and instructions stored in the memory and executable by the processor to cause the apparatus to perform a method of any of aspects 1 through 15.

Aspect 24: An apparatus for wireless communication at a UE, comprising at least one means for performing a method of any of aspects 1 through 15.

Aspect 25: A non-transitory computer-readable medium storing code for wireless communication at a UE, the code comprising instructions executable by a processor to perform a method of any of aspects 1 through 15.

Aspect 26: An apparatus for wireless communication at a first wireless device, comprising a processor; memory coupled with the processor; and instructions stored in the memory and executable by the processor to cause the apparatus to perform a method of any of aspects 16 through 18.

Aspect 27: An apparatus for wireless communication at a first wireless device, comprising at least one means for performing a method of any of aspects 16 through 18.

Aspect 28: A non-transitory computer-readable medium storing code for wireless communication at a first wireless device, the code comprising instructions executable by a processor to perform a method of any of aspects 16 through 18.

Aspect 29: An apparatus for wireless communication at a first wireless device, comprising a processor; memory coupled with the processor; and instructions stored in the memory and executable by the processor to cause the apparatus to perform a method of any of aspects 19 through 21.

Aspect 30: An apparatus for wireless communication at a first wireless device, comprising at least one means for performing a method of any of aspects 19 through 21.

Aspect 31: A non-transitory computer-readable medium storing code for wireless communication at a first wireless device, the code comprising instructions executable by a processor to perform a method of any of aspects 19 through 21.

Aspect 32: An apparatus comprising a processor; memory coupled with the processor; and instructions stored in the memory and executable by the processor to cause the apparatus to perform a method of any of aspect 22.

Aspect 33: An apparatus comprising at least one means for performing a method of any of aspect 22.

Aspect 34: A non-transitory computer-readable medium storing code the code comprising instructions executable by a processor to perform a method of any of aspect 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, at the UE and via a control channel, configuration information for communications between the UE and a wireless device over one or more reserved resources;
identifying, from the configuration information, an indication of a channel state information report periodicity; and
transmitting a channel state information report for a data channel in accordance with the channel state information report periodicity.

2. The method of claim 1, wherein identifying the indication of the channel state information report periodicity further comprises:
identifying the channel state information report periodicity as a sidelink-based channel state information report periodicity which is in terms of sidelink shared channel occasions.

3. The method of claim 1, wherein receiving the configuration information further comprises:
receiving the indication of the channel state information report periodicity via a radio resource control message from the wireless device, wherein the channel state information report periodicity is a sidelink-based channel state information report periodicity and the wireless device is a base station.

4. The method of claim 1, wherein receiving the configuration information further comprises:
receiving the indication of the channel state information report periodicity via a sidelink control channel, wherein the channel state information report periodicity is a sidelink-based channel state information report periodicity.

5. The method of claim 1, further comprising:
updating the channel state information report periodicity according to traffic statistics over the data channel, a change in a data channel characteristic, a rate of change of data channel characteristics of the data channel, a sequence of negative acknowledgement events, a sequence of acknowledgement events, or a function based at least in part on a number of negative acknowledgements.

6. The method of claim 5, further comprising:
receiving, from the wireless device, an indication of an updated channel state information report periodicity via the control channel, wherein updating the channel state information report periodicity is based at least in part on the indication of the updated channel state information report periodicity, and wherein the wireless device is a base station.

7. The method of claim 5, further comprising:
receiving a reactivation downlink control information message, wherein updating the channel state information report periodicity is based at least in part on the reactivation downlink control information message.

8. The method of claim 5, further comprising:
receiving a configured grant message that identifies resources for sidelink transmissions, wherein the indication of the channel state information report periodicity is indicated in the configured grant message.

9. The method of claim 1, further comprising:
applying the channel state information report periodicity upon an occurrence of a trigger.

10. The method of claim 9, wherein the trigger comprises receiving a configured grant or a start of a time slot reservation.

11. The method of claim 1, wherein identifying the indication of the channel state information report periodicity further comprises:
receiving indications of a plurality of channel state information report periodicities via the control channel; and
selecting the channel state information report periodicity from the plurality of channel state information report periodicities based at least in part on one or more parameters.

12. The method of claim 11, wherein the one or more parameters include a number of negative acknowledgement events, a number of acknowledgement events, a change in a data channel characteristic, and a processing load of the UE.

13. The method of claim 1, wherein identifying the indication of the channel state information report periodicity further comprises:
receiving the indication of the channel state information report periodicity in a sidelink control information message.

14. The method of claim 1, wherein the channel state information report periodicity is based at least in part on one or more of an application priority level or a quality of service value of the data channel.

15. The method of claim 14, further comprising:
receiving a configuration of an application priority level associated with the channel state information report periodicity in a radio resource configuration message or a downlink control information message.

16. A method for wireless communication at a first wireless device, comprising:
generating a sidelink control information message including an indication indicating a presence or an absence of a channel state information reference signal in a sidelink channel message; and
transmitting the sidelink control information message to a second wireless device.

17. The method of claim 16, wherein:
the indication comprises a one-bit flag,
a first value of the one-bit flag indicates that the channel state information reference signal is present in the sidelink channel message and a second value of the one-bit flag indicates that the channel state information reference signal is absent from the sidelink channel message.

18. The method of claim 16, wherein generating the sidelink control information message further comprises:
setting, based at least in part on a physical sidelink control channel occasion, a channel state information request indicator in the sidelink control information message that indicates to the second wireless device to send a channel state information report in a next available physical sidelink control channel resource.

19. A method for wireless communication at a first wireless device, comprising:
receiving, from a second wireless device, a sidelink control information message including an indication indicating a presence or an absence of a channel state information reference signal in a sidelink channel message;
generating a channel state information report for a data channel based at least in part on the indication; and
transmitting the channel state information report to the second wireless device.

20. The method of claim 19, wherein:
the indication comprises a one-bit flag, and
a first value of the one-bit flag indicates that the channel state information reference signal is present in the sidelink channel message and a second value of the one-bit flag indicates that the channel state information reference signal is absent from the sidelink channel message.

21. The method of claim 19, wherein receiving the sidelink control information message further comprises:
identifying a channel state information request indicator in the sidelink control information message that indicates when to transmit the channel state information report, wherein transmitting the channel state information report is based at least in part on the channel state information request indicator.

22. An apparatus for wireless communication at a user equipment (UE), comprising:
at least one processor; and
memory coupled to the at least one processor, the memory storing instructions executable by the at least one processor to cause the UE to:
receive, at the UE and via a control channel, configuration information for communications between the UE and a wireless device over one or more reserved resources;
identify, from the configuration information, an indication of a channel state information report periodicity; and
transmit a channel state information report for a data channel in accordance with the channel state information report periodicity.

23. The apparatus of claim 22, wherein the instructions to identify the indication of the channel state information report periodicity are further executable by the at least one processor to cause the UE to:
identify the channel state information report periodicity as a sidelink-based channel state information report periodicity which is in terms of sidelink shared channel occasions.

24. The apparatus of claim 22, wherein the instructions to receive the configuration information are further executable by the at least one processor to cause the UE to:
receive the indication of the channel state information report periodicity via a radio resource control message from the wireless device, wherein the channel state information report periodicity is a sidelink-based channel state information report periodicity and the wireless device is a base station.

25. The apparatus of claim 22, wherein the instructions to receive the configuration information are further executable by the at least one processor to cause the UE to:
receive the indication of the channel state information report periodicity via a sidelink control channel, wherein the channel state information report periodicity is a sidelink-based channel state information report periodicity.

26. The apparatus of claim 22, wherein the instructions are further executable by the at least one processor to cause the UE to:
update the channel state information report periodicity according to traffic statistics over the data channel, a change in a data channel characteristic, a rate of change of data channel characteristics of the data channel, a sequence of negative acknowledgement events, a sequence of acknowledgement events, or a function based at least in part on a number of negative acknowledgements.

27. The apparatus of claim 26, wherein the instructions are further executable by the at least one processor to cause the UE to:
receive, from the wireless device, an indication of an updated channel state information report periodicity via the control channel, wherein updating the channel state information report periodicity is based at least in part on the indication of the updated channel state information report periodicity, and wherein the wireless device is a base station.

28. The apparatus of claim 26, wherein the instructions are further executable by the at least one processor to cause the UE to:
receive a reactivation downlink control information message, wherein updating the channel state information report periodicity is based at least in part on the reactivation downlink control information message.

29. The apparatus of claim 26, wherein the instructions are further executable by the at least one processor to cause the UE to:
receive a configured grant message that identifies resources for sidelink transmissions, wherein the indication of the channel state information report periodicity is indicated in the configured grant message.

30. The apparatus of claim 22, wherein the instructions are further executable by the at least one processor to cause the UE to:
apply the channel state information report periodicity upon an occurrence of a trigger.
